(19) United States
(12) Patent Application Publication
(10) Pub. No.: US 2012/0278442 A1
(43) Pub. Date: Nov. 1, 2012

(54) SERVER APPARATUS AND METHOD OF CONTROLLING INFORMATION SYSTEM

(75) Inventor: Nobuyuki Saika, Yokosuka (JP)

(73) Assignee: HITACHI, LTD., Tokyo (JP)

(21) Appl. No.: 13/129,051

(22) PCT Filed: Apr. 26, 2011
(86) PCT No.: PCT/JP11/02445

§ 371 Date: May 12, 2011

(51) Int. Cl. G06F 15/16

(52) U.S. Cl. 709/219

(57) ABSTRACT

An object of the present invention is to efficiently use physical resources of a storage apparatus.

In an information system 1 including a first server apparatus 3a that performs data I/O to a first storage apparatus 10a, a second sever apparatus 3b that performs data I/O to a second storage apparatus 10b, a third server apparatus 3c that performs data I/O to a third storage apparatus 10c, a virtual volume being provided by the first storage apparatus 10a to the first server apparatus 3a by Thin Provisioning, data being migrated (first migration) from the first storage apparatus 10a to the second storage apparatus 10b as needed, and data being migrated (second migration) from the third apparatus 10c to the first storage apparatus 10a as needed, at the time of the second migration, of the files stored in the third storage apparatus 10c a file targeted for the first migration in an early stage is stored in the assigned-unused area of the virtual volume.

### TECHNICAL FIELD

The present invention relates to a server apparatus and a control method of an information system.

### BACKGROUND ART

PTL 1 discloses a remote copy system including a first storage system, a second storage system and a third storage system that perform data transfer with an information apparatus. In order to reduce volume usage of the second storage system in a case where data is copied from a first site to a third site, the second storage system includes a virtual second storage area and a third storage area to which data of the second storage area and data update information are written. Furthermore, data sent from the first storage system is not written in to the second storage area but written into the third storage area as data and update information. Then, the data and update information, written into the third storage area, are read by the third storage system.

PTL 2 discloses in AOU (Allocation on Use) technology, which is for allocating a storage area of a real volume in the pool to an area of a virtual volume accessed by an upper-level apparatus in a case where the virtual volume is accessed by the upper-level apparatus. In order to further improve the usage efficiency of the storage area, the invention detects a status where the allocation of the storage area of the real volume to the virtual volume need not be maintained as much, and, on the basis of the detection result, releases the allocation of the real volume storage to the virtual volume storage.

### CITATION LIST

### Patent Literature

PTL 1: Japanese Patent Application Laid-open Publication No. 2005-309550

PTL 2: Japanese Patent Application Laid-open Publication No. 2007-310861

### SUMMARY OF INVENTION

### Technical Problem

In an information system that includes a first storage apparatus, a second storage apparatus and a third storage apparatus that have functions of providing a virtual volume based on Thin Provisioning, files are transferred from the third storage apparatus to the first storage apparatus (hereinafter, referred to as “second transfer”) and, for files that satisfy a predetermined condition, from the first storage apparatus to the second storage apparatus (hereinafter, referred to as “first transfer”) whenever needed. In this case, the files that are transferred by the second transfer from the third storage apparatus to the first storage apparatus may be transferred at an early stage to the second storage apparatus by the first transfer.

Here, in the first storage apparatus, a physical resource (real volume) is assigned to the virtual volume area to which the files transferred by the second transfer are to be stored. However, after the files are transferred to the second storage apparatus by the first transfer, the real volume, although assigned to the virtual volume, remains unused, whereby the physical resource of the first storage apparatus is not used efficiently.

The present invention is made in view of the above and an object thereof is to provide a method of controlling a server apparatus and an information system with which the physical resources of a storage apparatus can be used efficiently.

### Solution to Problem

An aspect of this invention to achieve the above-mentioned object is a server apparatus serving as a first server apparatus in an information system including a first server apparatus that includes a file system and receives a data I/O request transmitted from an external apparatus to perform data I/O to a first storage apparatus, a second server apparatus that is communicatively coupled to the first server apparatus and performs data I/O to a second storage apparatus, and a third server apparatus that is communicatively coupled to the first server apparatus and performs data I/O to a third storage apparatus, the first storage apparatus providing the first server apparatus with a virtual volume being a virtual storage area provided by Thin Provisioning, wherein the first server apparatus performs as needed a first migration, by which an entity of a file, of files stored in the first storage apparatus, satisfying a predetermined condition is migrated into the second storage apparatus, performs as needed a second migration, by which an entity of a file stored in the third storage apparatus is migrated into the first storage apparatus, and stores in a predetermined area of a storage area of the virtual volume an entity of a file, of files stored in the third storage apparatus, satisfying the predetermined condition, at the time of the second migration.

Other problems and solutions to the problems disclosed by the present application will be made clear from the description in the Description of Embodiments and the drawings.

### ADVANTAGEOUS EFFECTS OF INVENTION

According to the present invention, physical resources of a storage apparatus can be used efficiently.

### BRIEF DESCRIPTION OF DRAWINGS

FIG. 1 illustrates an overall configuration of the information system 1.

FIG. 2 illustrates a hardware configuration of the client apparatus 2.

FIG. 3 illustrates a hardware configuration of the server apparatus 3.

FIG. 4 illustrates a hardware configuration of the storage apparatus 10.

FIG. 5 illustrates a hardware configuration of the channel board 11.

FIG. 6 illustrates a hardware configuration of the processor board 12.

FIG. 7 illustrates a hardware configuration of the drive board 13.

FIG. 8 illustrates basic functions of the storage apparatus 10.

FIG. 9 illustrates a flowchart of the write process S900.

FIG. 10 illustrates a flowchart of the read process S1000.

FIG. 11 illustrates primary functions of a first storage apparatus 10a and primary information (data) managed in the storage apparatus 10a.

FIG. 12 illustrates an exemplary virtual LU management table 831.

FIG. 13 illustrates an exemplary page management table 832.

FIG. 14 illustrates an exemplary real address management table 833.

FIG. 15 illustrates primary functions of the client apparatus 2.

FIG. 16 illustrates primary functions of the first server apparatus 3a and primary information (data) managed in the first server apparatus 3a.

FIG. 17 illustrates an exemplary replication information management table 331.

FIG. 18 illustrates an exemplary file access log 332.

FIG. 19 illustrates assignment/use status management table 333.

FIG. 20 illustrates primary functions of the second sever apparatus 3b.

FIG. 21 illustrates primary functions of the third server apparatus 3c.

FIG. 22 illustrates the file system structure 2200.

FIG. 23 illustrates a concept of Mode.

FIG. 24 illustrates the Mode management table 1912.

FIG. 25 illustrates the Mode management table 1912.

FIG. 26 illustrates the Mode management table 2212 according to the present embodiment.

FIG. 27 illustrates the replication start process S2700.

FIG. 28 illustrates a flowchart of the replication start process S2700.

FIG. 29 illustrates the stub candidate selection process S3100.

FIG. 30 illustrates a flowchart of the stub candidate selection process S3100.

FIG. 31 illustrates the stub process S3100.

FIG. 32 illustrates a flowchart of the stub process S3100.

FIG. 33 illustrates the replication file update process S3300.

FIG. 34 illustrates a flowchart of the replication file update process S3300.

FIG. 35 illustrates the replication file reference process S3500;

FIG. 36 illustrates a flowchart of the replication file reference process S3500.

FIG. 37 illustrates the synchronization process S3700.

FIG. 38 illustrates a flowchart of the synchronization process S3700.

FIG. 39 illustrates the meta data access process S3900.

FIG. 40 illustrates a flowchart of the meta-data access process S3900.

FIG. 41 illustrates the stub file entity reference process S4100.

FIG. 42 illustrates a flowchart of the stub file entity reference process S4100.

FIG. 43 illustrates the stub file entity update process S4300.

FIG. 44 illustrates a flowchart of the stub file entity update process S4300.

FIG. 45 illustrates the directory image pre-migration process S4500.

FIG. 46 illustrates a flowchart of the directory image pre-migration process S4500.

FIG. 47 illustrates the on-demand migration process S4700.

FIG. 48 illustrates a flowchart of the on-demand migration process S4700.

FIG. 49 illustrates how the directory images are migrated in turn.

FIG. 50 illustrates the directory image migration process S5000.

FIG. 51 illustrates a flowchart of the assigned-unused area reservation process S5014.

FIG. 52 illustrates a flowchart of the early migration target file extraction process S5200.

FIG. 53 illustrates a flowchart of the file list creation process S5222.

FIG. 54 illustrates an exemplary stub judgment policy 335.

FIG. 55 illustrates a flowchart of the batch migration process S5517.

FIG. 56 illustrates a flowchart of the detailed procedure of S5517 illustrated in FIG. 55.

FIG. 57 illustrates an exemplary area use limitation policy 336.

FIG. 58 illustrates an early migration target file list 5800.

### DESCRIPTION OF EMBODIMENTS

The embodiments of the present invention are described below with reference to the drawings.

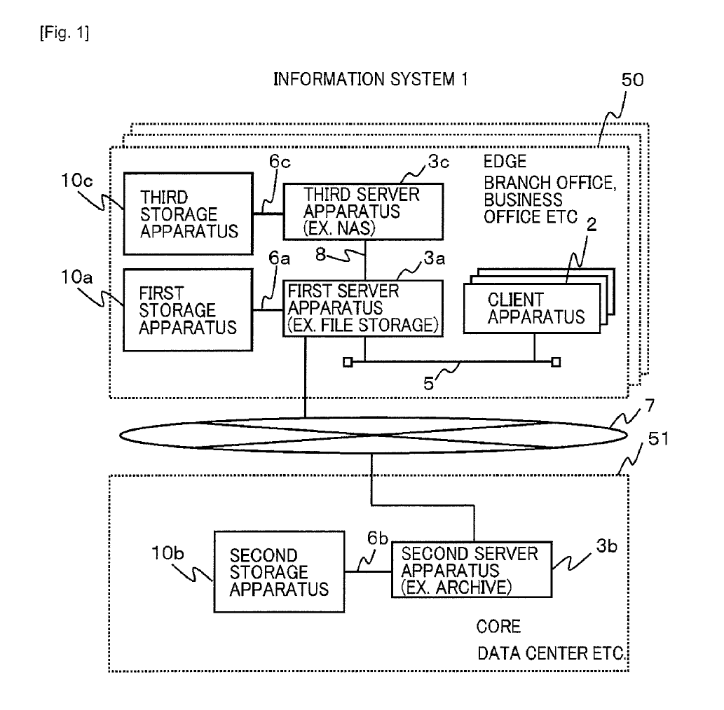

FIG. 1 illustrates an overall configuration of the information system 1, which is to be described as an embodiment. As described in FIG. 1, the information processing system 1 includes both hardware that is set up at the places where users actually handle business (hereinafter, referred to as “edge 50”) such as branch offices and business offices of companies such as trading companies, electronics manufacturers and the like, and hardware that is set up at the places like a data center where information systems (application server/storage system and the like) are managed and cloud services are provided (hereinafter, referred to as “core 51”).

As illustrated in FIG. 1, the edge 50 includes a first server apparatus 3a, a third server apparatus 3c, a first storage apparatus 10a, a third storage apparatus 10c, and a client apparatus 2 (external apparatus). The core 51 includes a second server apparatus 3b and a second storage apparatus 10b. The elements of the information system 1 are not necessarily located as illustrated in FIG. 1.

The first server apparatus 3a is, for example, a file storage apparatus that has a file system to provide a data management function in file units to the client apparatus 2.

The third server apparatus 3c accesses, in response to a request sent from the first server apparatus 3a, data stored in the third storage apparatus 10c. For example, the third server apparatus 3c is an NAS (Network Attached Storage) apparatus. The first server apparatus 3a and the third server apparatus 3c may be virtual machines that are realized with a virtualization control unit (host-OS type, hypervisor type, or the like).

The storage system including the third server apparatus 3c and the third storage apparatus 10c is, for example, a system that has been offering services directly to the client apparatus 2 (storage system with an old specification, a storage system with a different specification, standard and performance different from the new system, storage system made by a third party or the like. Hereinafter, referred to as “old system”) before the storage system including the first server apparatus 3a and the first storage apparatus 10a (hereinafter, referred to as “new system”) was installed in the edge 50.

The second server apparatus 3b is, for example, an apparatus (archive apparatus) that functions as a data library (archive) of the first storage apparatus 10a of the edge 50. The second server apparatus 3b is, for example, realized by utilizing resources provided by cloud services. The second server apparatus 3b may be a virtual machine that is realized with a virtualization control mechanism (host-OS type, hypervisor type, or the like).

The client apparatus 2 and the first server apparatus 3a are communicatively coupled via a first communication network 5. The first server apparatus 3a is communicatively coupled with the first storage apparatus 10a of the edge 50 via a first storage network 6a.

The first server apparatus 3a is communicatively coupled with the second server apparatus 3b of the core 51 via a second communication network 7. In the core 51, the second server apparatus 3b is communicatively coupled with the second storage apparatus via a second storage network 6b.

In the edge 50, the third server apparatus 3c and the third storage apparatus 10c are communicatively coupled via a third storage network 6c. The first server apparatus 3a and the third server apparatus 3c are communicatively coupled a third communication network 8.

The first communication network 5, the second communication network 7 and the third communication network 8 are, for example, LAN (Local Area Network), WAN (Wide Area Network), the Internet, public lines or special purpose lines.

The first storage network 6a, the second storage network 6b and the third storage network 6c are, for example, LAN, SAN (Storage Area Network), the Internet, public lines or special purpose lines.

Communication via first communication network 5, the second communication network 7, the third communication network 8, the first storage network 6a, the second storage network 6b and the third storage network 6c complies, for example, with protocols such as TCP/IP, iSCSI (internet Small Computer System Interface), fibre channel protocol, FICON (Fibre Connection) (Registered Trademark), ESCON (Enterprise System Connection) (Registered Trademark), ACONARC (Advanced Connection Architecture) (Registered Trademark) and FIBARC (Fibre Connection Architecture) (Registered Trademark).

The client apparatus 2 is an information apparatus (computer) that uses storage areas provided by the first storage apparatus 10a via the first server apparatus 3a. The client apparatus 2 is, for example, a personal computer, office computer, notebook computer or tablet-type mobile terminal. The client apparatus 2 runs an operating system, applications and the like that are realized by software modules (file system, kernel, driver, and the like).

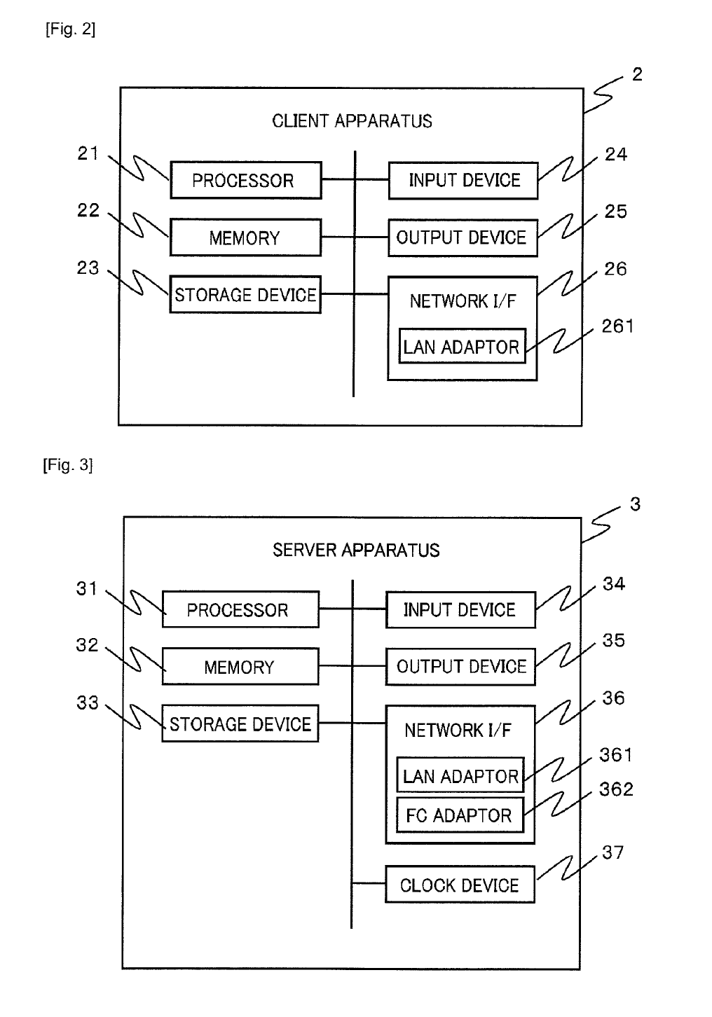

FIG. 2 illustrates hardware of the client apparatus 2. As illustrated in FIG. 2, the client apparatus 2 includes a processor 21, a volatile or non-volatile memory 22 (RAM (Random Access Memory)), a ROM (Read Only Memory), an NVRAM (Non Volatile RAM), a storage device 23 (HDD (Hard Disk Drive), semi-conductor storage device (SSD (Solid State Drive) and the like)), an input device 24 (keyboard, mouse, touch panel and the like), an output device 25 (liquid crystal monitor, printer, and the like), and a communication interface (referred to as “network I/F 26”) such as an NIC (Network Interface Card) (Hereinafter, “LAN adapter 261”).

The first server apparatus 3a is an information apparatus that offers services to the client apparatus 2 using the first storage apparatus 10a as the data storage destination. The first server apparatus 3a includes, for example, a computer such as a personal computer, a main frame (Mainframe) and an office computer.

When accessing the storage area provided by the first storage apparatus 10a, the first server apparatus 3a sends a data frame (hereinafter, simply referred to as “frame”), including a data I/O request (data write request, data read request or the like), to the first storage apparatus 10a via the first storage network 6a. The frame is, for example, a fibre channel frame (FC frame (FC: Fibre Channel)).

The second server apparatus 3b is an information apparatus that offers services using the storage area of the second storage apparatus 10b. The second server apparatus 3b includes such as a personal computer, a main frame and an office computer. When accessing the storage area provided by the second storage apparatus 10b, sends a frame, including a data I/O frame, to the second storage apparatus 10b via the second storage network 6b.

FIG. 3 illustrates hardware of the first server apparatus 3a. The second server apparatus 3b and the third server apparatus 3c include the same or similar hardware configuration as the first server apparatus 3a.

As illustrated in FIG. 3, the first server apparatus 3a includes a processor 31, a volatile or nonvolatile memory 32 (RAM, ROM, NVRAM or the like), a storage device 33 (HDD, semi-conductor storage device or the like), an input device 34 (keyboard, mouse or the like), an output device 35 (liquid crystal monitor, printer or the like), a communication interface (hereinafter, “network I/F 36”) (NIC (hereinafter, referred to as “LAN adapter 361”), an HBA (hereinafter, referred to as “FC adapter 362”) or the like), and a clock device 37 including a timer circuit, an RTC and the like.

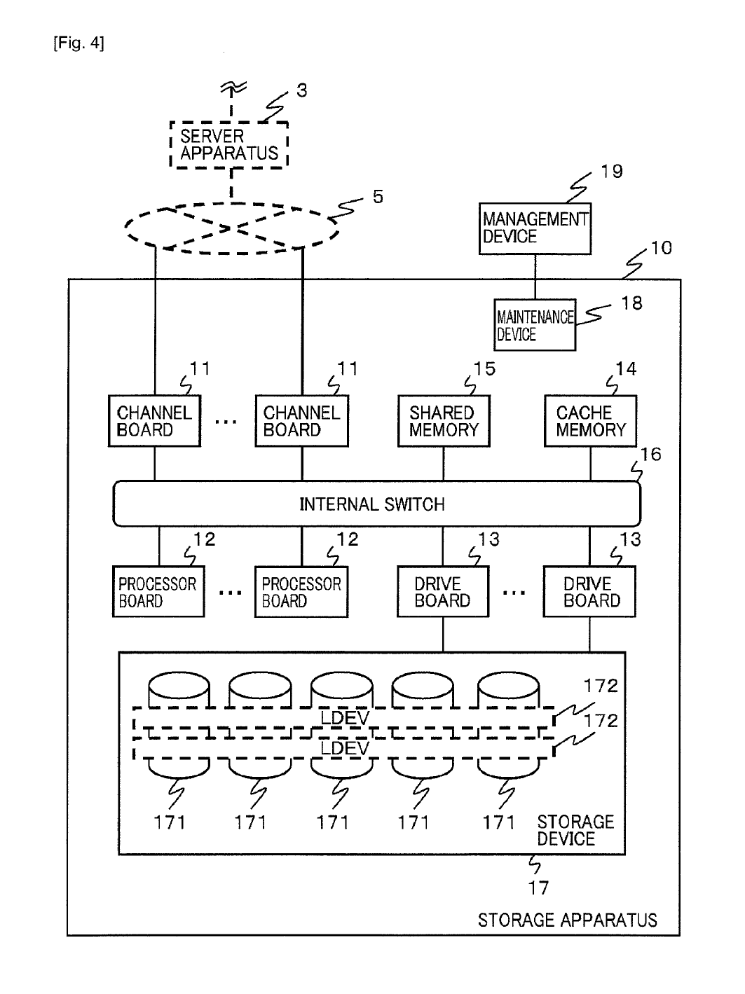

FIG. 4 illustrates a hardware configuration of the storage apparatus 10 (the first storage apparatus 10a, the second storage apparatus 10b and the third storage apparatus 10c). The storage apparatus 10 is, for example, a disk-array apparatus. The storage apparatus 10 receives a data I/O request that is sent from a server apparatus 3 (the first server apparatus 3a, the second server apparatus 3b and the third server apparatus 3c), accesses a storage medium in response to the received data I/O request, and then sends data or a response to the server apparatus 3.

As illustrated in FIG. 4, the storage apparatus 10 includes one or more channel boards 11, one or more processor boards 12 (Micro Processor), one or more drive boards 13, a cache memory 14, a shared memory 15, an internal switch 16, a clock device 17 and a maintenance device 18 (SVP: SerVice Processor). The channel board 11, the processor board 12, the drive board 13, the cache memory 14 and the shared memory 15 are communicatively coupled with each other via the internal switch 16.

The channel board 11 receives a frame sent from the server apparatus 3 and sends a frame, including response to a process (data I/O) for the data I/O request included in the received frame (e.g., data that has been read, a read completion report, a write completion report), to the server apparatus 3.

In response to the above data I/O request in the frame received by the channel board 11, the processor board 12 performs a process for data transfer (high-speed large-file data transfer using a DMA (Direct Memory Access) or the like) among the channel board 11, the drive board 13 and the cache memory 14. The processor board 12 performs, for example, transfer (i.e., delivery) of data between the channel board 11 and the drive board 13 (data read from the storage device 17, data to be written into the storage device 17) or staging (i.e., reading data from the storage device 17) of data to be stored in the cache memory 14.

The cache memory 14 includes a RAM (Random Access Memory) that can be accessed at high speed. The cache memory 14 stores therein data to be written in the storage device 17 (hereinafter, referred to as “write data”) or data that is read from the storage device 17 (hereinafter, referred to as “read data”). The shared memory 15 stores therein various kinds of information for controlling the storage apparatus 10.

The drive board 13 performs communication with the storage device 17 in a case where data is read from the storage device 17 or data is written into the storage device 17. The internal switch 16 includes, for example, a high-speed cross bar switch. The communication via the internal switch 16 complies, for example, with protocols such as fibre channel, iSCSI and TCP/IP.

The storage device 17 includes a plurality of storage drives 171. The storage drive 171 is, for example, a hard disk drive or a semi-conductor storage device (SSD) that complies with SAS (Serial Attached SCSI), SATA (Serial ATA), FC (Fibre Channel), PATA (Parallel ATA), SCSI or the like.

The storage device 17 provides storage areas of the storage device 17 to the server apparatus 3 in units of logical storage areas provided by controlling the storage drives 171, for example, according to methods such as RAID (Redundant Arrays of Inexpensive (or Independent) Disks). The logical storage area is, for example, a storage area of a logical device (LDEV 172 (LDEV: Logical Device)) realized with a RAID group (Parity Group).

The storage apparatus 10 provides the server apparatus 3 with logical storage areas (hereinafter, referred to as “LU (Logical Unit, Logical Volume)”) using LDEV 172. The LUs have independent identifiers (hereinafter, referred to as “LUN”). The storage apparatus 10 manages associations (relationships) between the LUs and LDEVs 172. On the basis of these associations, the storage apparatus 10 identifies an LDEV 172 corresponding to an LU or identifies an LU corresponding to an LDEV 172. In addition this type of LU, the first storage apparatus 10a provides the server apparatus 3 with an LU that is virtualized based on Thin Provisioning (hereinafter, referred to as “virtual LU”), which is described later.

FIG. 5 illustrates a hardware configuration of the channel board 11. As illustrated in FIG. 5, the channel board 11 includes an external communication interface (hereinafter, referred to as external network I/F 111) including a port (i.e., communication port) for communicating with the server apparatus 3, a processor 112 (including a frame processing chip and a frame transfer chip), a memory 113, and an internal communication interface (hereinafter, referred to as “internal network I/F 114) including a port (i.e., communication port) for communicating with the processor board 12.

The external I/F 111 includes an NIC (Network Interface Card), an HBA (Host Bus Adaptor) and the like. The processor 112 includes a CPU (Central Processing Unit), an MPU (Micro Processing Unit) and the like. The memory 113 is a RAM (Random Access Memory) or a ROM (Read Only Memory). The memory 113 stores therein micro programs. The processor 112 reads and executes the micro programs in the memory 113 whereby various kinds of functions provided by the channel board 11 are realized. The internal network I/F 114 communicates with the processor board 12, the drive board 13, the cache memory 14 and the shared memory 15 via the internal switch 16.

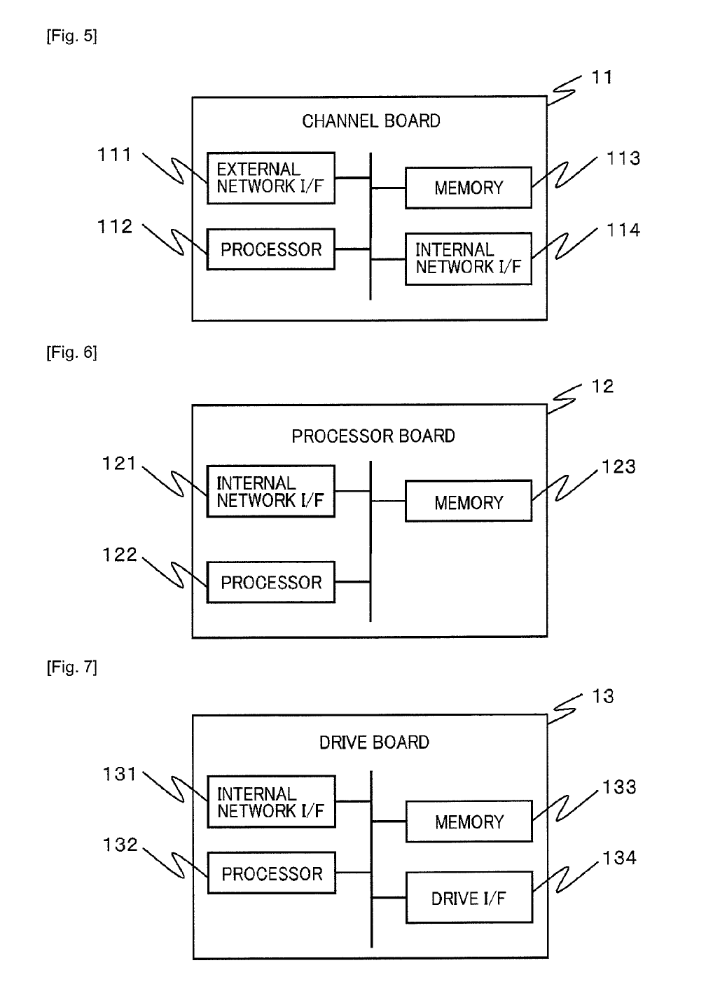

FIG. 6 illustrates a hardware configuration of the processor board 12. The processor board 12 includes an internal communication interface (hereinafter, referred to as “internal network I/F 121”), a processor 122, and a memory 123 (local memory) that has better accessibility (can be accessed at higher speed) from the processor 122 than the shared memory 15. The memory 123 stores therein micro programs. The processor 122 reads and executes the micro programs in the memory 123 whereby various kinds of functions provided by the processor board 12 are realized.

The internal network I/F 121 communicates with the channel board 11, the drive board 13, the cache memory 14 and the shared memory 15 via the internal switch 16. The processor 122 includes a CPU, an MPU, a DMA (Direct Memory Access) and the like. The memory 123 is a RAM or a ROM. The processor 122 can access to both the memory 123 and the shared memory 15.

FIG. 7 illustrates a hardware configuration of the drive board 13. The drive board 13 includes an internal communication interface (hereinafter, referred to as “internal network I/F 131”), a processor 132, a memory 133 and a drive interface (hereinafter, referred to as “drive I/F 134”). The memory 133 includes micro programs. The processor 132 reads and executes the micro programs in the memory 133 whereby various kinds of functions provided by the drive board 13 are realized. The internal network I/F 131 communicates with the channel board 11, the processor board 12, the cache memory 14 and the shared memory 15 via the internal switch 16. The processor 132 includes a CPU, an MPU and the like. The memory 133 is, for example, a RAM or a ROM. The drive I/F 134 communicates with the storage device 17.

The maintenance device 18 illustrated in FIG. 4 controls and monitors the elements of the storage apparatus 10. The maintenance device 18 is a personal computer, an office computer or the like. The maintenance device 18 communicates, when needed, with the elements of the storage apparatus 10 such as the channel board 11, the processor board 12, the drive board 13, the cache memory 14, the shared memory 15 and the internal switch 16, via the internal switch 16 and a communication means such as a LAN, whereby the maintenance device 18 acquires operation information and the like from the elements and then provides them to the management device 19. Furthermore, the maintenance device 18 performs setting, controlling and maintenance (including installation and update of software) on the basis of the control information and the operation information sent from the management device 19.

The management device 19 is a computer that is communicatively coupled with the maintenance device 18 via the LAN or the like. The management device 19 includes a user interface (GUI (Graphical User Interface), CLI (Command Line Interface), and the like) for controlling and monitoring the storage apparatus 10.

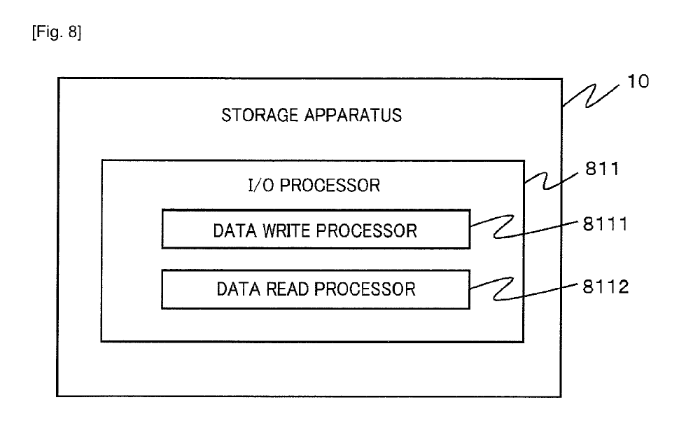

FIG. 8 illustrates the basic functions of the storage apparatus 10. As illustrated in FIG. 8, the storage apparatus 10 includes an I/O processor 811. The I/O processor 811 includes a data write processor 8111 that performs processes related to writing of data into the storage device 17 and a data read processor 8112 that performs processes related to reading of data from the storage device 17.

The I/O processor 811 is realized with hardware of the channel board 11, the processor board 12 or the drive board 13 or is realized by the processor 112, the processor 122 or the processor 132 reading and executing micro programs stored in the memory 113, the memory 123 or the memory 133.

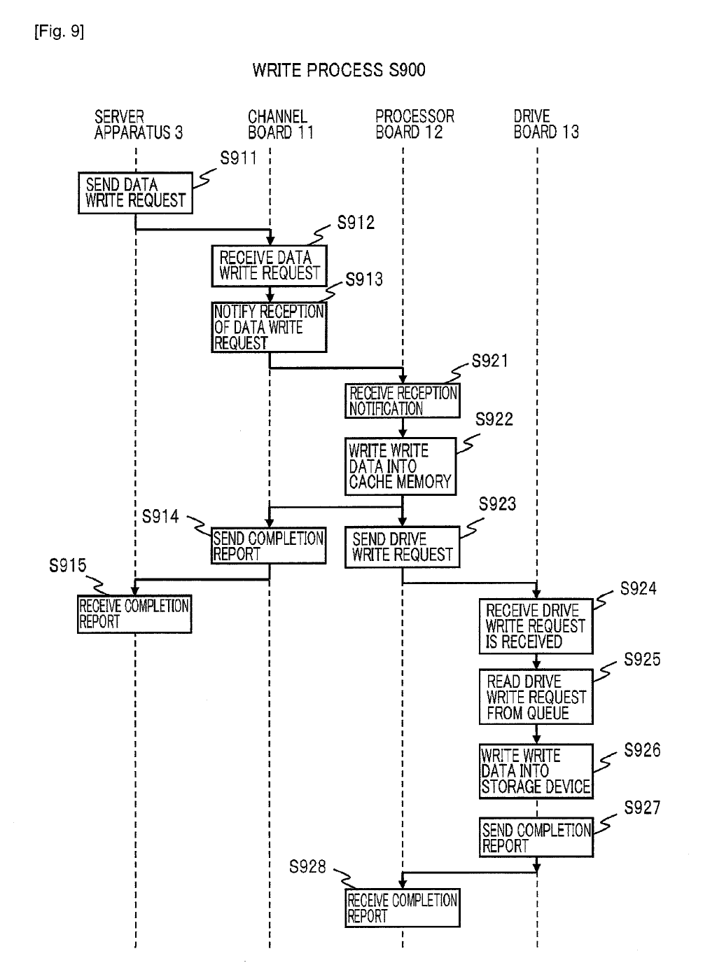

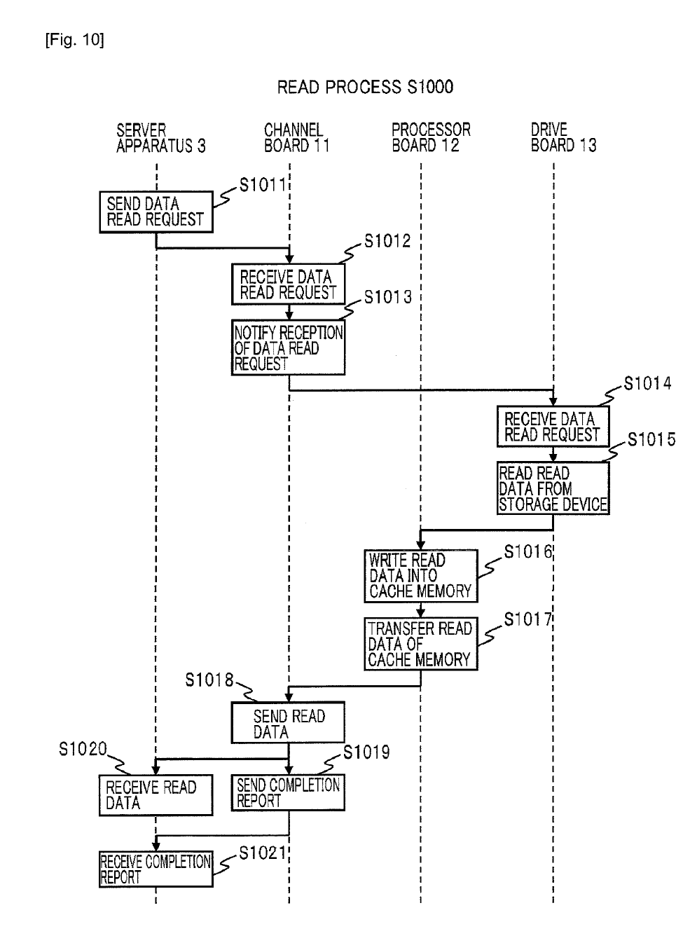

FIG. 9 illustrates a flowchart of basic processes (hereinafter, referred to as “write process S900”) that are performed by the data write processor 8111 of the I/O processor 81 when the storage apparatus 10 receives a frame including a data read request from the server apparatus 3. The following describes the write process S900 with reference to FIG. 9. The character “S” attached to the numerals, which appears in the following description, stands for Step.

As illustrated in FIG. 9, a frame of the data read request, sent from the server apparatus 3, is received by the channel board 11 of the storage apparatus 10 (S911 and S912).

When the channel board 11 receives the frame including the data write request from the server apparatus 3, the channel board 11 sends a notification of this reception to the processor boar 12 (S913).

When the processor board 12 receives the notification from the channel board 11 (S921), the processor board 12 generates a drive write request based on the data write request of the frame, stores the write data in the cache memory 14, and responds by sending back a notification of receiving the notification to the channel board 11 (S922). The processor board 12 sends the generated drive write request to the drive board 13 (S923).

Upon receiving the response, the channel board 11 sends a completion report to the server apparatus 3 (S914). Accordingly, the server apparatus 3 receives the completion report from the channel board 11 (S915).

Upon receiving the drive write request from the processor board 12, the drive board 13 registers the received drive write request in a write queue (S924).

The drive board 13 reads, when needed, the drive write request from the write queue (S925), reads the write data, specified by the drive write request that has been read, from the cache memory 14 and then writes the write data into the storage device (storage drive 171) (S926). The drive board 13 sends a report, indicating that the write data has been written according to the drive write request, (completion report) to the processor board 12 (S927).

The processor board 12 receives the completion report sent from the drive board 13 (S928).

FIG. 10 illustrates a flowchart of the I/O process that is performed by the read processor 8112 of the I/O processor 811 in the storage apparatus 10 (hereinafter, referred to as “read process S1000”) when the storage apparatus 10 receives the frame including the data read request from the server apparatus 3. The following describes the read process S1000 with reference to FIG. 10.

As illustrated in FIG. 10, the frame, sent from the server apparatus 3, is received by the channel board 11 of the storage apparatus 10 (S1013).

Upon receiving the frame including the data read request from the server apparatus 3, the channel board 11 sends a notification to the drive board 13 (S1013).

When the drive board 13 receives the notification from the channel board 11 (S1014), the drive board 13 reads the data, specified by the data read request of the frame (e.g., specified using LBA (Logical Block Address)), from the storage device (storage drive 171) (S1015). Further, if read data exists in the cache memory 14 (i.e., in case of a cache hit), the read process from the storage device 17 (S1015) is skipped.

The processor board 12 writes the data that has been read by the drive board 13 into the cache memory 14 (S1016). The processor board 12 transfers, when needed, the data written into the cache memory 14 to the channel board 11 (S1017).

Receiving the read data that is sent from the processor board 12 as needed, the channel board 11 sequentially sends the read data to the server apparatus 3 (S1018). After the sending of the read data is completed, the channel board 11 sends a completion report to the server apparatus 3 (S1019). The server apparatus 3 receives the read data and the completion report (S1020, S1021).

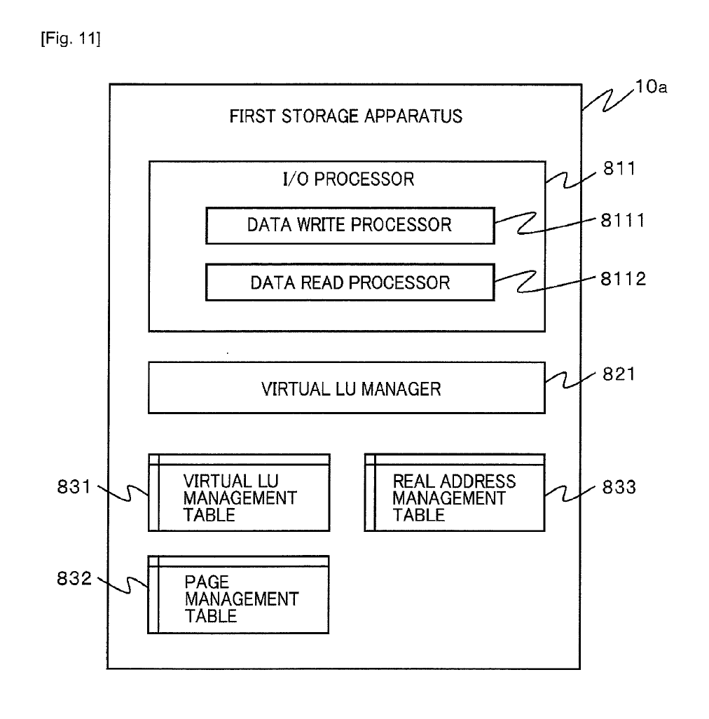

FIG. 11 illustrates the primary functions of the first storage apparatus 10a and the primary data that is managed by the first storage apparatus 10a. As illustrated in FIG. 11, the first storage apparatus 10a includes a virtual LU manager 821 in addition to the I/O processor 811 described above. Further, the first storage apparatus 10a manages (stores) a virtual LU management table 831, a page management table 832, and a real address management table 833.

The virtual LU manager 821 is realized with hardware of the channel board 11, the processor board 12 or the drive board 13 or realized by the processor 112, the processor 122 or the processor 132 reading and executing micro programs stored in the memory 113, the memory 123 or the memory 133.

The virtual LU manager 821 implements the functions related to Thin Provisioning.

With Thin Provisioning, the group of storage areas of the LDEVs 172 is managed as a storage pool. The storage area of the storage pool is managed in units of storage areas with a fixed length (hereinafter, referred to as “page”). The allocation of a storage area of a physical resource to the virtual LU is performed in units of pages.

Thin Provisioning is a technology which enables allocation, to an external apparatus (server apparatus 3),of a storage area of an amount equal to or greater than that can be provided by physical resources that is prepared by the storage system , regardless of physical resources actually prepared by the storage system. The virtual LU manager 821 provides a page to a virtual LU depending on the amount of data that has been actually written into the virtual LU (depending on the usage status of the virtual LU).

As described above, in Thin Provisioning, physical resources are actually provided for the server apparatus 3 depending on the amount of data that is actually written into the virtual LU, whereby a storage area of a size greater than that can be provided by the physical resources prepared by the storage apparatus 10, regardless of the actual amount of physical resources prepared by the storage apparatus 10. Therefore, the use of Thin Provisioning can, for example, simplify the capacity planning of the storage system.

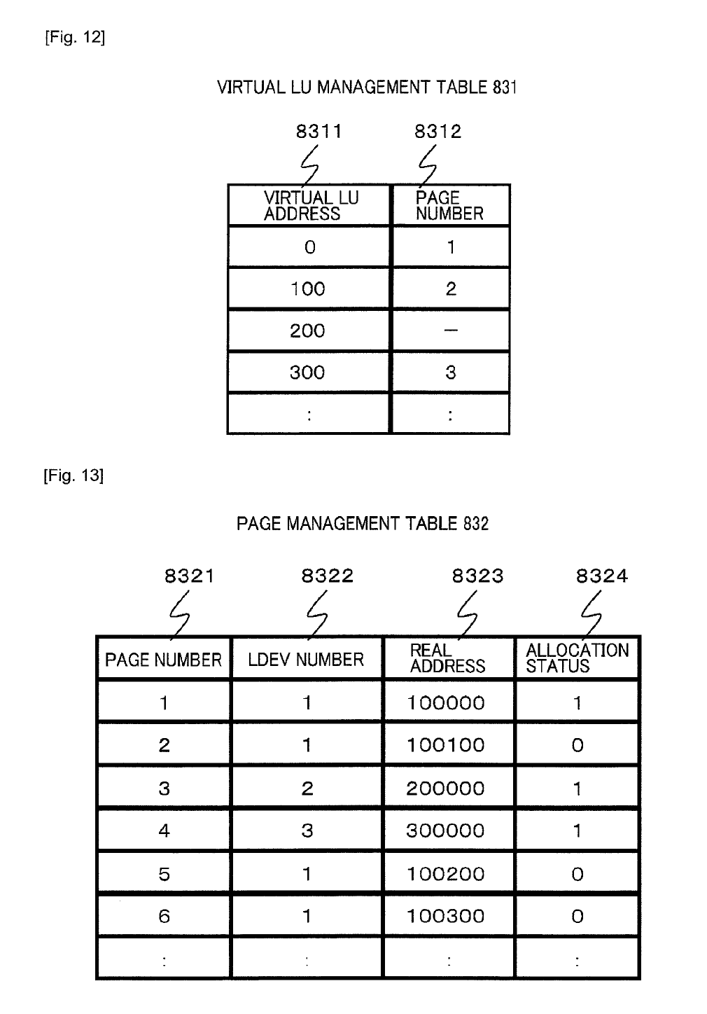

In the virtual LU management table 831 illustrated in FIG. 11, relationships between the virtual LU and the pages currently allocated to the virtual LU are managed. FIG. 12 illustrates an exemplary virtual LU management table 831. As illustrated in FIG. 12, the virtual LU management table 831 includes one or more records where a data block address (LBA (Logical Block Address) and the like) (hereinafter, this address is referred to as virtual LU address 8311) in the storage area space of the virtual LU is associated with an identifier of a page (hereinafter, referred to as “page number 8312”).

In the page management table 832 illustrated in FIG. 11, the relationship between a page and an LDEV 172 is managed. FIG. 13 illustrates an exemplary page management table 832. As illustrated in FIG. 13, the page management table 832 includes one or more records where the page number 8321, the identifier of the LDEV 172 (hereinafter, referred to as “LDEV number 8322”), the address (LBA or the like) in the storage area space of the LDEV 172 (hereinafter, this address is referred to as “physical address 8323”), and an allocation status 8324 are associated with each other. The allocation status 8324 has set therein information indicating whether or not the page is currently allocated to the virtual LU (“1” is set if the page is currently allocated to the virtual LU; “0” is set if not).

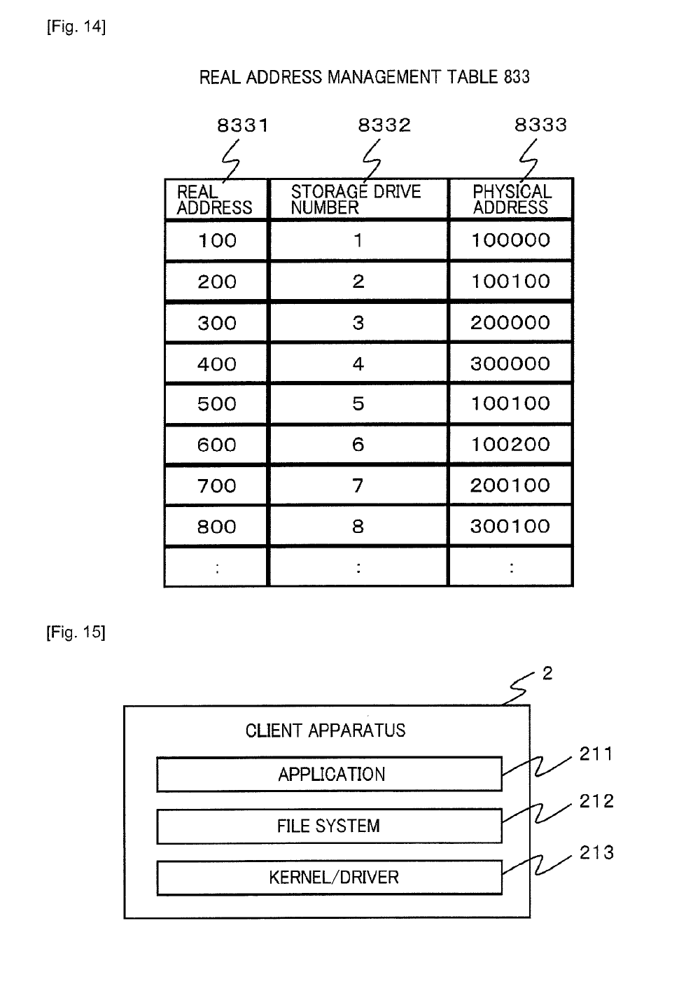

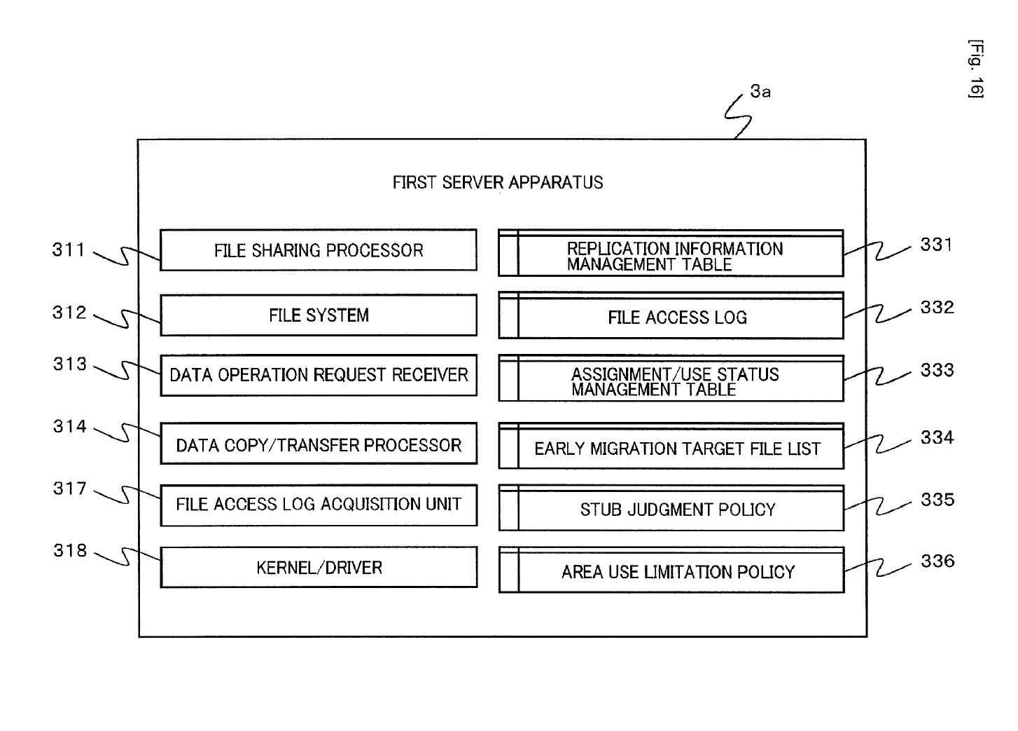

The real address management table 833 illustrated in FIG. 11 manages the relationship between the storage area of the LDEV 172 and the storage area of the storage drive 171. FIG. 14 illustrates an exemplary real address management table 833. As illustrated in FIG. 14, the real address management table 833 includes one or more records where a physical address 8331 of the LDEV 172, an identifier of the storage drive (or a RAID group) of the LDEV 172 (hereinafter, referred to as “storage drive number”), an address in a storage area space of the storage drive 171 (or RAID group) (hereinafter, referred to as “physical address”) are associated with each other.

When the first storage apparatus 10a receives a data write request from the first server apparatus 3a (or when the data write request is generated in the first storage apparatus 10a), the first storage apparatus 10a refers to the virtual LU management table 831 for the appended virtual LU address to identify the page number 8312 and refers to the allocation status 8324 of the page management table 832 to check whether the page is currently allocated to the virtual LU. If the page is currently allocated to the virtual LU, the first storage apparatus 10a performs a write process (data I/O) by which the write data appended to the data write request is written into the real address 8323 of the LDEV number 8322 of the page that is identified from the page management table 832.

On the other hand if the page is currently not allocated to the virtual LU, the first storage apparatus 10a refers to the allocation status 8324 of the page management table 832 and obtains the page number 8312 of the page that is currently not allocated to the virtual LU. Then, the first storage apparatus 10a obtains the LDEV number 8322 and the real address 8323 corresponding to the obtained page number 8312 from the page management table 832. The first storage apparatus 10a writes the write data into the physical storage area that is identified by checking the obtained LDEV number 8322 and physical address 8323 against the physical address management table 833. Along with this process, the first storage apparatus 10a updates the contents of the virtual LU management table 831 and the page management table 832 into statuses after the writing process.

FIG. 15 illustrates primary functions of the client apparatus 2. As illustrated in FIG. 15, the client apparatus 2 has functions of an application 211, a file system 212, and a kernel/driver 213. These functions are realized by the processor 21 of the client apparatus 2 reading and executing the programs that are stored in the memory 22 or the storage device 23.

The file system 212 implements the I/O function to the logical volume (LU) in a unit of file or directory for the client apparatus 2. The file system 212 is, for example, FAT (File Allocation Table), NTFS, HFS (Hierarchical File System), ext2 (second extended file system), ext3 (third extended file system), ext4 (fourth extended file system), UDF (Universal Disk Format), HPFS (High Performance File system), JFS (Journaled File System), UFS (Unix File System), VTOC (Volume Table of Contents), XFS and the like.

The kernel/driver 213 is implemented by executing kernel modules and driver modules included in software of an operating system. The kernel module includes programs for implementing basic functions of an operating system such as management of a process, scheduling of a process, management of a storage area, handling of an interruption request from hardware for software executed by the client apparatus 2. The drive module includes programs for communication of a kernel module with hardware of the client apparatus 2 or peripheral devices coupled to the client apparatus 2.

FIG. 16 illustrates primary functions of the first server apparatus 3a and primary information (data) that is managed by the first server apparatus 3a. As illustrated in FIG. 16, the first server apparatus 3a has functions of a file sharing processor 311, the file system 312, a data operation request receiver 313, a data copy/transfer processor 314, a file access log acquisition unit 317, and the kernel/driver 318.

These functions are realized with hardware of the first server apparatus 3a or realized by the processor 31 of the first server apparatus 3a reading and executing the programs stored in the memory 32. Further, the functions of the data operation request receiver 313, the data copy/transfer processor 314, the file access log acquisition unit 317 may be implemented as a function of the file system 312 or may be implemented as a function that is independent from the file system 312.

As illustrated in FIG. 16, the first server apparatus 3a manages (stores) information (data) such as a replication information management table 331, a file access log 332, an assignment/use status management table 333, and an early migration target file list 334, a stub judgment policy 335 and an area use limitation policy 336. These pieces of information are, for example, stored in the memory 32 or the storage device 33 of the first server apparatus 3a.

Of the functions illustrated in FIG. 16, the file sharing processor 311 provides file sharing environment to the client apparatus 2. The file sharing processor 911 provides, for example, functions that comply with NFS (Network File System), CIFS (Common Internet File System), AFS (Andrew File System) and the like.

The file system 312 provides the client apparatus 2 with I/O function to the files (or directories) managed in the logical volume (LU) provided by the first storage apparatus 10a. The file system 312 is, for example, FAT (File Allocation Table), NTFS, HFS (Hierarchical File System, ext2 (second extended file system), ext3 (third extended file system), ext4 (fourth extended file system), UDF (Universal Disk Format), HPFS (High Performance File system), JFS (Journaled File System), UFS (Unix File System), VTOC (Volume Table of Contents), XFS and the like.

The data operation request receiver 313 receives a request related to operation of data (hereinafter, referred to as “data operation request”) that is sent from the client apparatus 2. The data operation request includes a replication start request, a replication file update request, replication file reference request, a synchronization request, a meta-data access request, a file entity reference request, a recall request, a stub file entity update request, and the like.

Stubbing is a process by which meta data of file data (or directory data) is managed (stored) in the first storage apparatus 10a while the entity of file data (or directory data) is not managed (stored) in the first storage apparatus 10a but is managed (stored) only in another storage apparatus (e.g., the second storage apparatus 10b). Stub indicates meta data that remains in the first storage apparatus 10a through the above-mentioned process. When the first server apparatus 3a receives a data I/O request that requires the entity of the stubbed file (or directory), the entity of the file (or directory) is sent from another storage apparatus 10 to the first storage apparatus 10a (hereinafter, referred to as “recall”).

The data copy/transfer processor 314 handles sending and receiving of data (including meta data or the entity of a file) with another server apparatus 3 (the second server apparatus 3b and the third server apparatus 3c) or with the storage apparatus 10 (the first storage apparatus 10a, the second storage apparatus 10b and the third storage apparatus 10c), sending and receiving control information (including a flag and a table), and management of the various tables.

The kernel/driver 318 illustrated in FIG. 16 is implemented by executing kernel modules and driver modules included in a software of an operating system. The kernel module includes programs for implementing basic functions of an operating system such as management of a process, scheduling of a process, management of a storage area, handling of an interruption request from hardware, for software executed by the first server apparatus 3a. The drive module includes programs for communication of a kernel module with hardware of the first server apparatus 3a or peripheral devices coupled to the first server apparatus 3a.

When there is an access to a file (file update (write, update), file read (Read), file open (Open), file close (Close) or the like) in the logical volume (LU or virtual LU) of the storage apparatus 10, the file access log acquisition unit 317 appends a time stamp based on the date information acquired from the clock device 37, to information indicating a content (history) of the access (hereinafter, referred to as “access log”) and stores the information as a file access log 332.

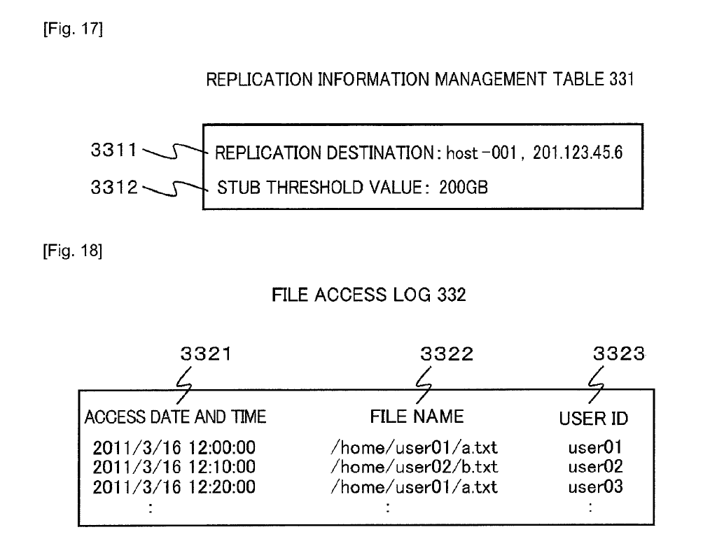

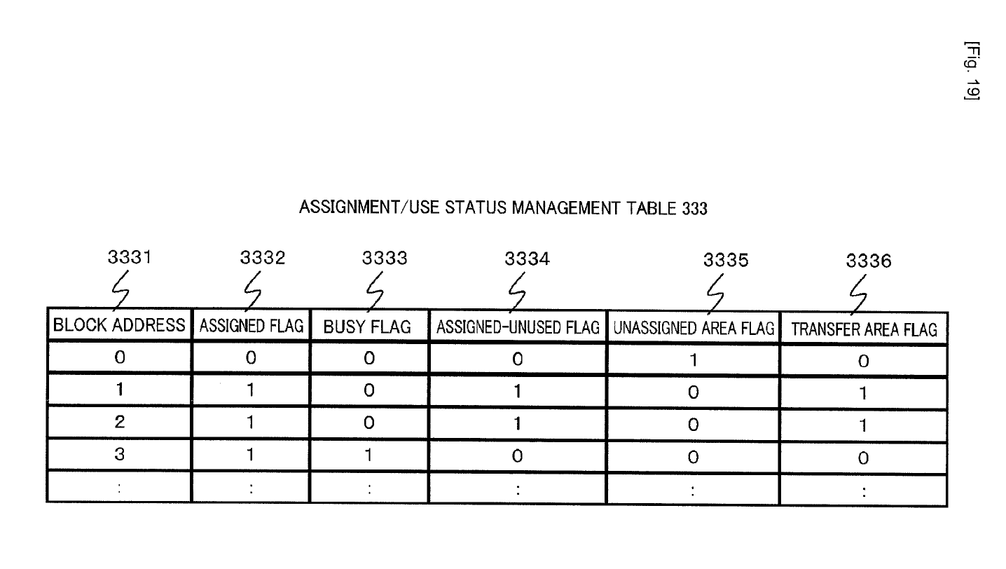

FIG. 17 illustrates an exemplary replication information management table 331. As illustrated in FIG. 17, the replication information management table 331 includes a host name 3311 (e.g., network address such as an IP address) and a threshold value 3312 that is used for determining whether stubbing is to be performed or not (hereinafter, referred to as “stub threshold value”).

FIG. 18 illustrates an exemplary file access log 332. As illustrated in FIG. 18, the file access log 332 records an access log of one or more records including access date and time 3351, file name 3352 and user ID 3353.

The access date and time 3351 has set therein the date and time the file (or directory) had been accessed. The file name 3352 has set therein a file name (or directory name) of a file (or directory) that has been targeted for an access. The user ID 3353 has set therein a user ID of a user who accessed the file (or directory).

FIG. 19 illustrates an exemplary assignment/use status management table 333. The assignment/use status management table 333 manages an assignment status of physical resources to each data block of virtual LUs provided for the first server apparatus 3a from the first storage apparatus 10a (whether or not the data block is currently assigned the page from the storage pool), and the current use status of each data block (whether or not the data block currently stores valid data).

As illustrated in FIG. 19, the assignment/use status management table 333 includes one or more records including a block address 3331, an assigned flag 3332, a busy flag 3333, an assigned-unused flag 3334, an unassigned area flag 3335, and a transfer area flag 3336.

A block address of a virtual LU is set in the block address 3331. Information indicating whether the physical resource (page) is currently allocated to the block address 3331 or not is set in the assigned flag 3332. “1” is set if a physical resource is allocated; “0” is set if not.

Information indicating whether the block address 3331 is currently in use or not (whether valid data is stored in the data block or not) is set in the busy flag 3333. “1” is set if valid data is currently stored in the data block; “0” is set if not.

Information, indicating whether a physical resource (page) is currently allocated to the data block but the data block is not in use (hereinafter, referred to as “allocated free status”) or not, is set in the assigned-unused flag 3334. “1” is set if the data block is currently in the assigned-unused status; “0” is set if it is not.

Information indicating that a physical resource is currently not allocated to the data block is set in the unassigned area flag 3335. “1” is set if a physical resource is currently not allocated; “0” is set if it is allocated.

The transfer area flag 3336 is used when it is necessary to secure in advance a data block that is to be used as a migration destination upon migrating data from the third server apparatus 3c (the third storage apparatus 10c) to the first server apparatus 3a (the first storage apparatus 10a). “1” is set in the transfer area flag 3336 if the data block is reserved in advance; “0” is set if not. The data block for which the transfer area flag 3336 is set is exclusively controlled and can no longer be used for use besides a migration destination data block in the case of data migration.

The setting of the transfer area flag 3336 may be, for example, registered manually by a user using a user interface provided by the first server apparatus 3a. Alternatively, the transfer area flag 3336 may be set automatically by the first server apparatus 3a.

The value of the unallocated free flag 3334 can be obtained from the following logical operation.

Value of the unallocated free flag 3334=(Value of the assigned flag 3332) XOR (Value of the busy flag 3333) (Formula 1)

The value of the unassigned area flag 3335 can be calculated with the following logical operation.

Value of the unassigned area flag 3335=(NOT (Value of the assigned flag 3332)) AND (NOT (Value of the busy flag 3333)) (Formula 2)

In the example illustrated in FIG. 19, the assignment status and the use status of a physical resource to the storage area to a virtual LU is managed in units of block addresses 3331. Instead, for example, the status of the storage area of the virtual LU may be managed in other management units, e.g., units of chunks (a group of a certain number of block addresses). Details of the early migration file list 334, the stab judgment policy 335 and the area use limitation policy 336 illustrated in FIG. 16 are described later.

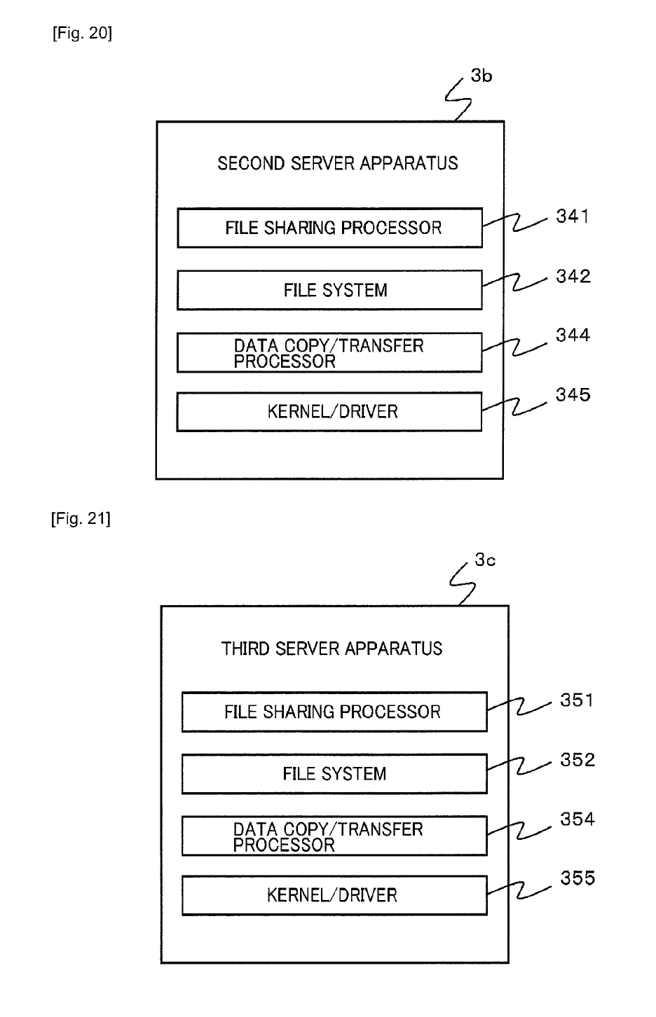

FIG. 20 illustrates primary functions of the second server apparatus 3b. As illustrated in FIG. 20, the second server apparatus 3b includes functions of a file sharing processor 341, a file system 342, a data copy/transfer processor 344 and a kernel/deriver 345. The function of the data copy/transfer processor 344 may be implemented as a function of the file system 342 or may be realized as a function that is independent from the file system 342.

The file sharing processor 341 provides a file sharing environment with the first server apparatus 3a. The file sharing processor 341 is implemented, for example, according to protocols such as an NFS, CIFS and AFS.

The file system 342 uses the logical volume (LU) provided by the second storage apparatus 10b and provides the first server apparatus 3a with an I/O function to the logical volume (LU or virtual LU) in units of files or units of directories. The file system 342 is, for example, FAT, NTFS, HFS, ext2, ext3, ext4, UDF, HPFS, IFS, UFS, VTOC and XFS.

The data copy/transfer processor 344 perform processes related to transfer or copying of data with the first server apparatus 3a, and the second storage apparatus 10b.

The kernel/driver 345 is implemented by executing kernel modules and drive modules included in software of an operating system. The kernel module includes programs for implementing basic functions of an operating system such as management of a process, scheduling of a process, management of a storage area, handling of an interruption request from hardware for software executed by the second server apparatus 3b. The drive module includes programs for communication of a kernel module with hardware of the second server apparatus 3b or peripheral devices coupled to the second server apparatus 3b.

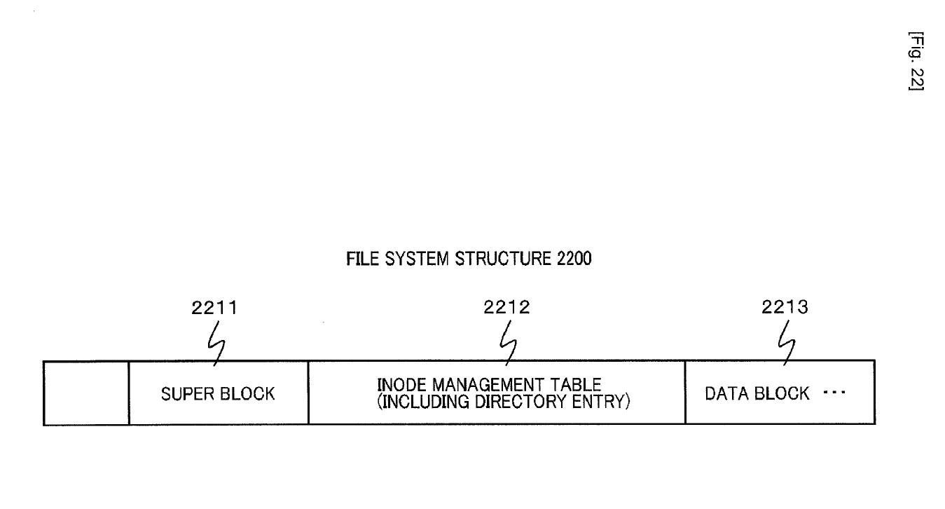

FIG. 21 illustrates primary functions of the third server apparatus 3c. As illustrated in FIG. 21, the third server apparatus 3c includes functions of a file sharing processor 351, a file system 352, a data copy/transfer processor 354 and a kernel/driver 355. The function of the data copy/transfer processor 354 may be realized as a function of the file system 352 or may be realized as a function that is independent from the file system 352.

The file sharing processor 351 provides a file sharing environment with the first server apparatus 3a. The file sharing processor 351 is realized, for example, according to protocols such as an NFS, CIFS and AFS.

The file system 352 uses a logical volume (LU) of the third storage apparatus 10c and provides the first server apparatus 3a with an I/O function to the logical volume (LU or virtual LU) in units of files or units of directories. The file system 352 is, for example, FAT, NTFS, HFS, ext2, ext3, ext4, UDF, HPFS, JFS, UFS, VTOC and XFS.

The data copy/transfer processor 354 performs processes related to transfer and copying of data among the first server apparatus 3a and the third storage apparatus 10c.

The kernel/driver 355 is implemented by executing kernel modules and drive modules included in software of an operating system. The kernel module includes programs for implementing basic functions of an operating system such as management of a process, scheduling of a process, management of a storage area, handling of an interruption request from hardware, for software executed by the third server apparatus 3c. The drive module includes programs for communication of a kernel module with hardware of the third server apparatus 3c or peripheral devices coupled to the third server apparatus 3c.

<File System>

The configuration of the file system 312 of the first server apparatus 3a is described below in detail. The file system 342 of the second server apparatus 3b and the file system 352 of the third server apparatus 3c have the same or similar configuration with the file system 312 of the first server apparatus 3a.

FIG. 22 illustrates an exemplary data structure (hereinafter, referred to as “file system structure 2200”) managed by the file system 312 in the logical volume (LU or virtual LU). As illustrated in FIG. 22, the file system structure 2200 includes storage areas such as a super block 2211, an Mode management table 2212 and a data block 2213 in which the entity (data) of a file is stored.

The super block 2211 stores therein information related to the file system 312 (capacity, used capacity and free capacity of storage areas handled by the file system). The super block 2211 is normally set for each disk segment (partition that is set in a logical volume (LU or virtual LU)). A specific example of such information stored in the super block 2211 includes a number of data blocks in the segment, size of data block, number of free blocks, number of free Modes, number of mounts in the segment, and elapsed time since the latest consistency check.

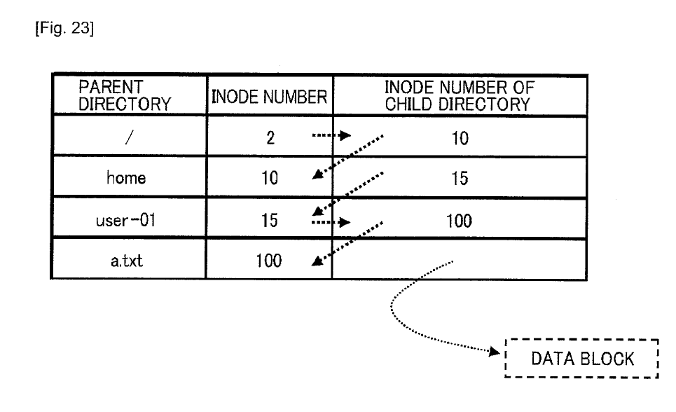

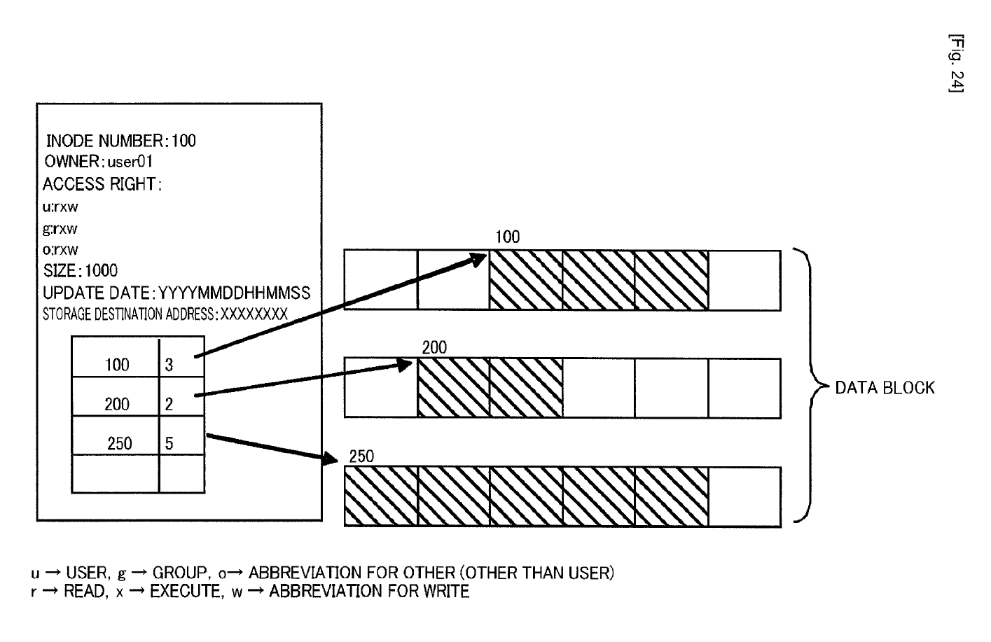

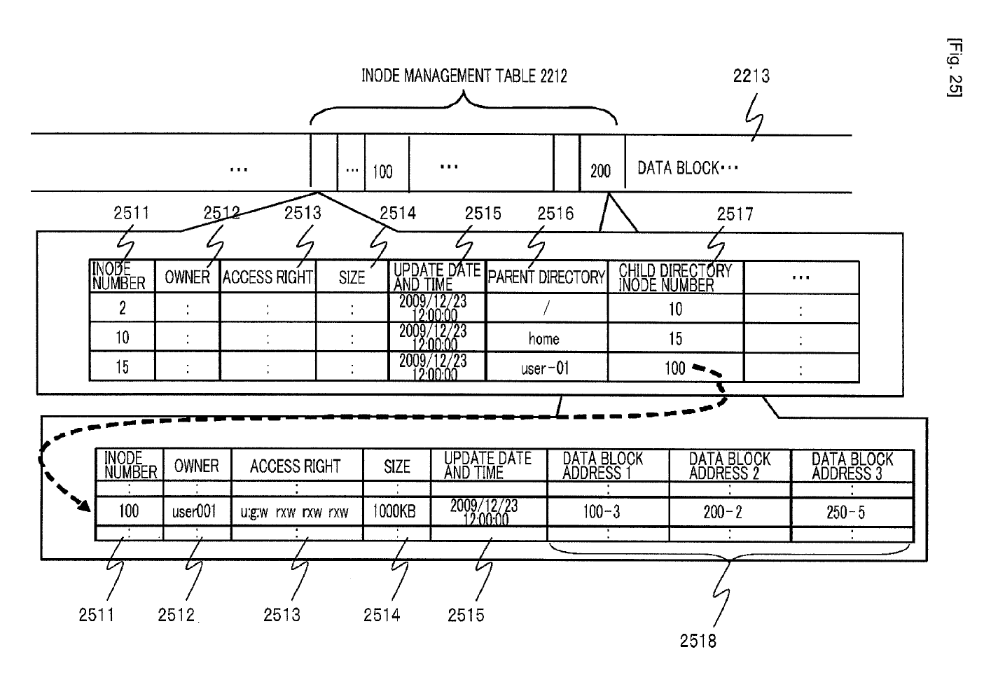

The Mode management table 2212 stores therein management information (hereinafter, referred to as “Mode”) of files (or directories) stored in the logical volume (LU or virtual LU). The file system 312 manages a file (or a directory) that is associated with a single Mode. Modes that include only the directory-related information is called a “directory entry”. When there is an access to a file, a directory entry is referred to, and then the data block of the access target file is accessed. For example, in order to access the file at “/home/user-01/a.txt”, the Mode numbers and the directory entries are traced in the order illustrated by arrows in FIG. 23 (2->10->15->100) to access the data block of the access target file.

FIG. 24 illustrates a concept of an Mode in a general file system (e.g., file system used by the UNIX (Registered Trademark) type operating system). FIG. 25 illustrates an exemplary Mode management table 2212.

As illustrated in FIGS. 24 and 25, the Mode includes pieces of information such as inode number 2511, owner 2512 of the file (or directory), access right 2513 that is set for the file (or directory), file size 2514 of the file (or directory), latest update date and time 2515 of the file (or directory), parent directory 2516 of the directory that is set when the Mode is a directory entry, child directory 2517 of the directory if the Mode is a directory entry, and information for specifying data blocks stored in the entity of the data of the file (hereinafter, referred to as “block address 2518”).

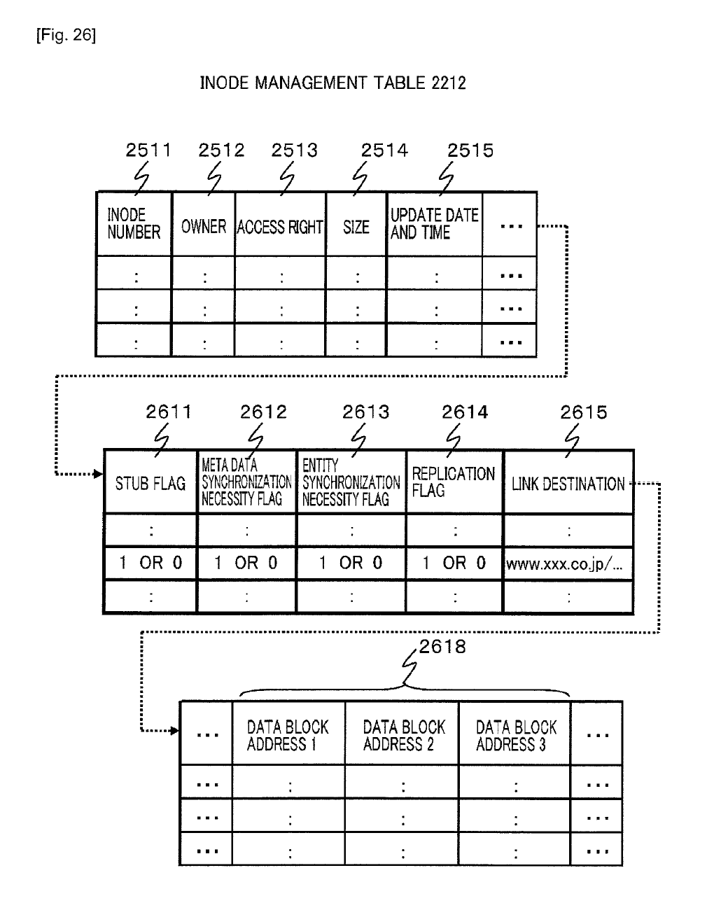

As illustrated in FIG. 26, the file system 312, other than the contents of an Mode management table 2212 in a common file system, manages a stub flag 2611, a meta-data synchronization necessity flag 2612, an entity synchronization necessity flag 2613, a replication flag 2614, a link destination 2615 and priority 2616 in a manner such that these pieces of information are attached to the mode management table 2212.

If a copy of the meta data of the file stored in the first storage apparatus 10a (meta data included in the various pieces of attached information illustrated in FIG. 26) are also stored in the second storage apparatus 10b (i.e., when replication is produces) with a management method by replication or a management method by stubbing, when meta data in one of the apparatuses is updated by the later described synchronization process S3700, a notification of such event is sent to the other apparatus. In this way, contents of the meta data of the first storage apparatus 10a and the meta data of the second storage apparatus 10b remain consistent on a real-time basis.

In FIG. 26, information indicating whether the file (or directory) corresponding to the

Mode is stubbed or not is set in the stub flag 2611. “1” is set in the stub flag 2611 if the file (or directory) corresponding to the Mode is stubbed; “0” is set in the stub flag 2611 if not.

Information indicating whether the meta data of the file (or directory) of the first storage apparatus 10a, which is a copy source, needs to be synchronized with the meta data of the file (or directory) of the second storage apparatus 10b, which is a copy destination, or not (whether contents need to be consistent with each other) is set in the meta data synchronization necessity flag 2612. “1” is set in the meta data synchronization necessity flag 2612 if the synchronization of the meta data is necessary; “0” is set in the meta data synchronization necessity flag 2612 if the synchronization is not necessary.

Information indicating whether the entity of the file data of the first storage apparatus 10a, which is a copy source, needs to be synchronized with the entity of the file data of the second storage apparatus 10b, which is a copy destination, or not (whether contents need to be consistent with each other) is set in the entity synchronization necessity flag 2613. “1” is set in the entity synchronization necessity flag 2613 if the entity of file data needs to be synchronized; “0” is set in the entity synchronization necessity flag 2613 if the synchronization is not necessary.

The meta data synchronization necessity flag 2612 and the entity synchronization necessity flag 2613 are referred to as needed at the synchronization process S3700 described later. If either the meta data synchronization necessity flag 2612 or the entity synchronization necessity flag 2613 is set at “1”, the meta data or entity of the first storage apparatus 10a is automatically synchronized with the meta data or entity of the second storage apparatus 10b, which is a copy of the file data.

Information indicating whether the file (or directory) corresponding to the Mode is currently to be managed with the replication management method described later or not is set in the replication flag 2614. “1” is set in the replication flag 2614 if the file corresponding to the Mode is currently to be managed with the replication management method; “0” is set if it is not to be managed with the replication management method.

If the file corresponding to the mode is managed with the replication management method described later, information indicating a copy destination of the file (e.g., a path name, an identifier of a RAID group, a block address, a URL (Uniform Resource Locator), LUN and the like to specify the storage destination) is set in the link destination 2615.

=Explanation of Processes=

The processes performed in the information system 1 having the above-mentioned configuration is described below. To begin with, the following describes the processes performed among the first server apparatus 3a (file storage apparatus) of the edge 50, the second server apparatus 3b (archive apparatus) of the core 51.

<Replication Starting Process>

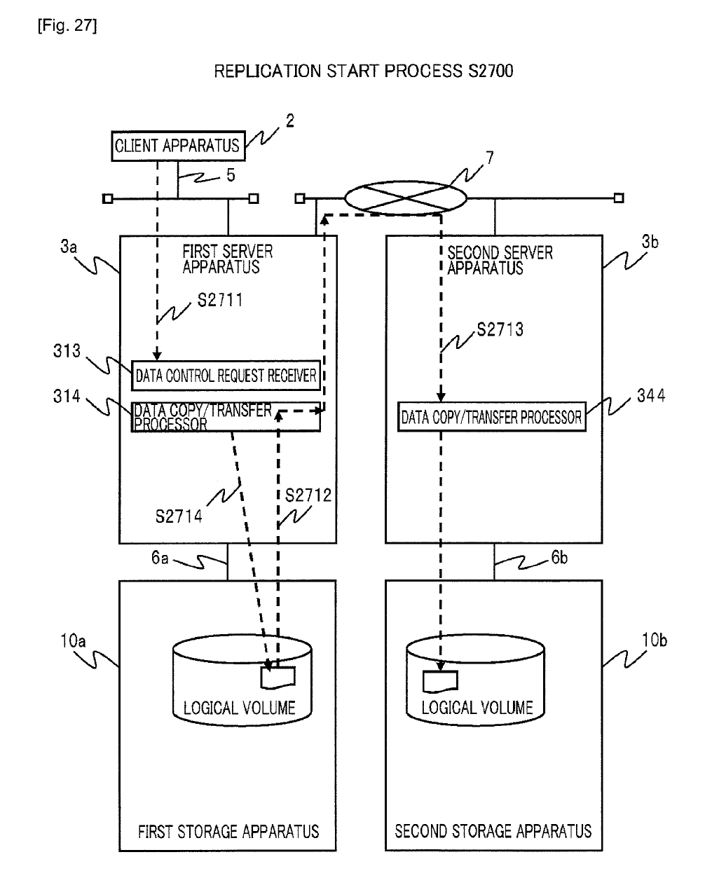

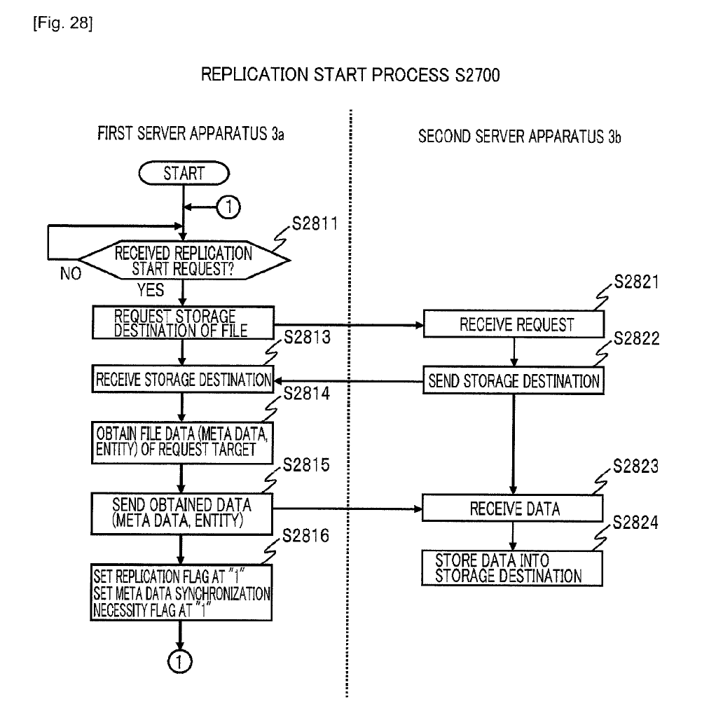

FIG. 27 illustrates a process that is performed in the information system 1 (hereinafter, referred to as “replication start process S2700”) in case of an event where the first server apparatus 3a receives a request for starting replication (copying) of the file stored in the first storage apparatus 10a (hereinafter, referred to as “replication start request”). FIG. 28 illustrates a flowchart to explain the details of the replication start process S2700 in FIG. 27. These figures are referred to in the description below.

Upon receiving the replication start request from the client apparatus 2, the first server apparatus 3a starts to manage the files that are specified by the request, according to the replication management method. Other than the reception of the replication start request from the client apparatus 2 via the first communication network 5, the first server apparatus 3a may receive the replication start request that is internally generated in the first server apparatus 3a.

The replication management method is a method where the file data (meta data or entity) is managed both in the first storage apparatus 10a and the second storage apparatus 10b. When the entity or meta data of a file stored in the first storage apparatus 10a is updated under the replication management method, the meta data or entity of the file of the second storage apparatus 10b, which is managed as the copy (or archive file) of the file, is updated in a synchronous or asynchronous manner. With the replication management method, consistency of the file data (meta data or entity) stored in the first storage apparatus 10a and the file data (meta data or entity) stored as a copy in the second storage apparatus 10b is secured (guaranteed) in a synchronous or asynchronous manner.

The meta data of the file (archive file) of the second storage apparatus 10b may be managed as a file (as a file entity). In this case, even if the specification of the file system 312 of the first server apparatus 3a is different from the specification of the file system 342 of the second server apparatus 3b, the replication management method can be used for the operation.

The first server apparatus 3a monitors on a real time basis whether or not a replication start request is received from the client apparatus 2 (S2811). When the first server apparatus 3a receives a replication start request from the client apparatus 2 (S2711) (S2811: YES), the first server apparatus 3a sends an inquiry to the second server apparatus 3b for the storage destination (identifier of a RAID group, block address and the like) of file data (meta data or entity) that is specified by the received replication start request (S2812).

When the above-mentioned inquiry is received (S2821), the second server apparatus 3b determines the storage destination of the file data by searching free areas in the second storage apparatus 10b and sends a notification of the determined storage destination to the first server apparatus 3a (S2822).

When the first server apparatus 3a receives the notification (S2813), the first server apparatus 3a reads the file data (meta data or entity) specified by the received replication start request from the first storage apparatus 10a (S2712) (S2814) and sends the data of the read file to the second server apparatus 3b along with the storage destination obtained at S2822.

The first server apparatus 3a sets “1” in the replication flag 2614 and the meta data synchronization necessity flag 2612 of the meta data of the file (meta data of the file stored in the first storage apparatus 10a) (S2714) (S2816).

By setting “1” in the meta data synchronization necessity flag 2612, the consistency of the meta data of the file stored in the first storage apparatus 10a and the meta data of the file stored as a copy in the second storage apparatus 10b is secured (guaranteed) in a synchronous or asynchronous manner at the synchronization process S3700 described later.

When the second server apparatus 3b receives the file data from the first server apparatus 3a (S2823), the second server apparatus 3b stores the received file data in the storage area of the second storage apparatus 10b specified by the storage destination that is received along with the file (S2824).

<Stub Candidate Selection Process>

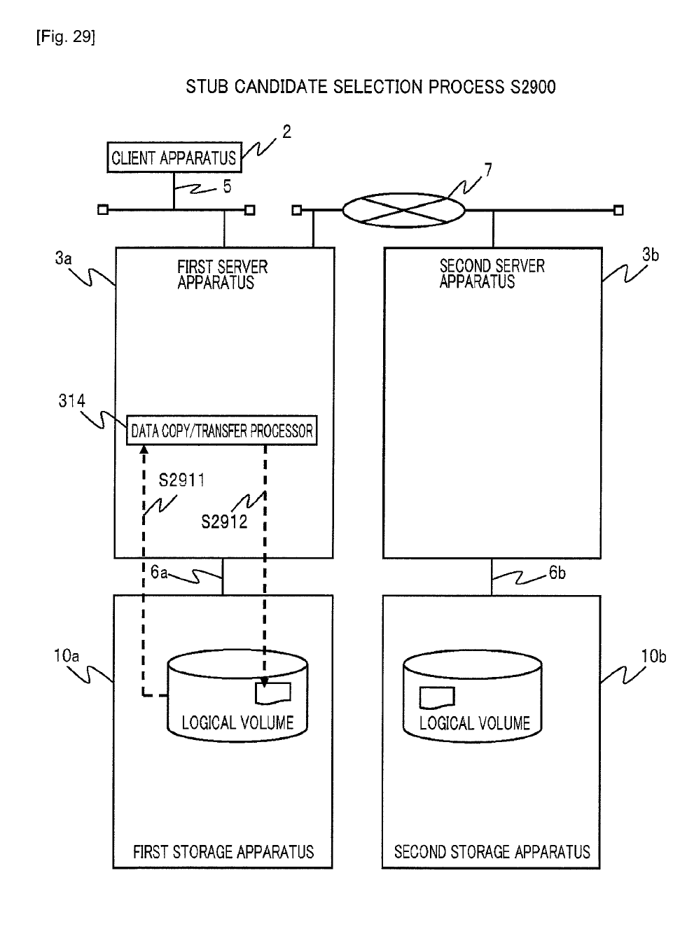

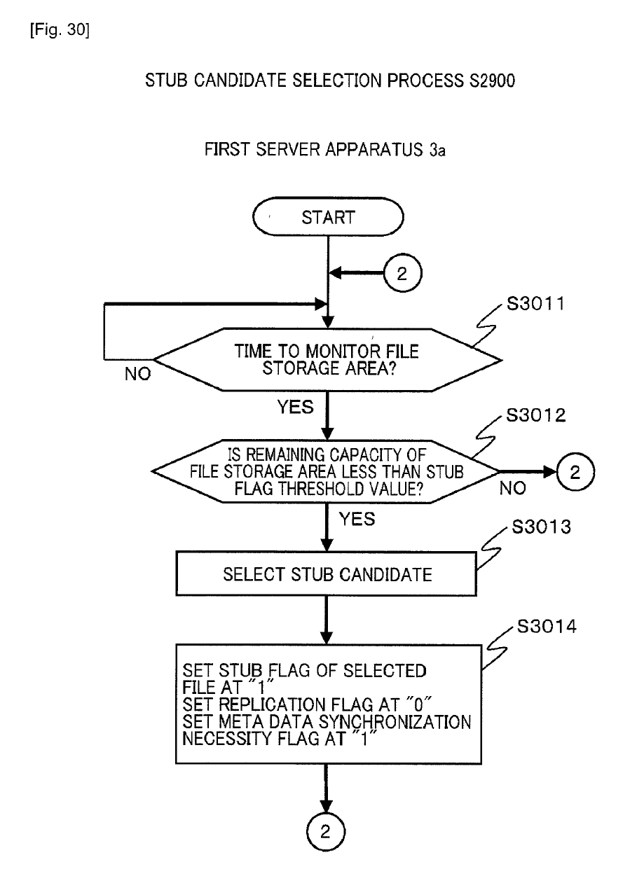

FIG. 29 illustrates processes that are performed by the information system 1 in order to set the file being managed under the replication management process (file whose replication flag 2314 is set at “1”, hereinafter, referred to as “replication file”), of the files being stored in the first storage apparatus 10a, as a candidate for the stubbing described above (hereinafter, referred to as “stub candidate selection process S2900”). FIG. 30 illustrates a flowchart of the stub candidate selection process S2900. The following is described with reference to these figures.

As illustrated in FIG. 30, the first server apparatus 3a monitors the remaining capacity of file storage areas as needed (real time, regular intervals, predetermined timings, etc). When the remaining capacity of the storage area of the first storage apparatus 10a that is allocated to the file system 312 as the file storage area (hereinafter, referred to as “file storage area”) is less than a predetermined threshold value (stubbing threshold value) (S3011: YES, S3012: YES), the first server apparatus 3a selects candidates for the stubbing from the replication files stored in the first storage apparatus 10a on the basis of the predetermined selection criteria (S2911) (S3013). The predetermined selection criteria (predetermined conditions) may be, for example, chronological order of the latest update date and time or ascending order of frequency (e.g., access frequency obtained from the file access log 332) of the access. The candidates may be selected on the basis of the predetermined stub judgment policy 335 (predetermined condition) as described later.

After the selection of the candidates for stubbing, the first server apparatus 3a sets “1” in the stub flag 2611 of the selected replication file, sets “0” in the replication flag 2614, and sets “1” in the meta data synchronization necessity flag 2612 (S2912) (S3014). The first server apparatus 3a obtains the remaining capacity of the file storage area from, for example, the information managed by the file system 312.

<Stub Process (First Migration)>

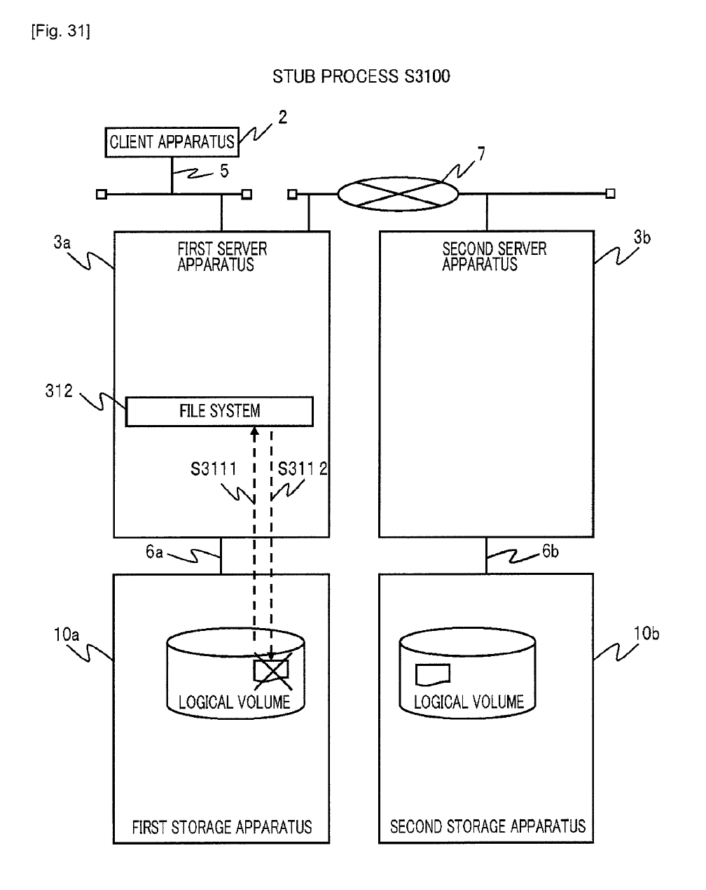

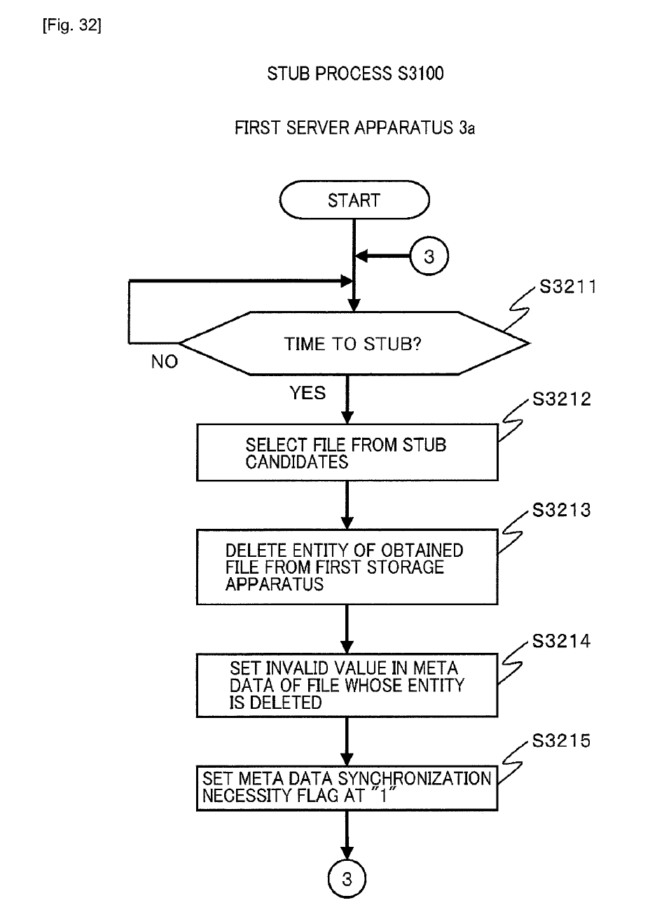

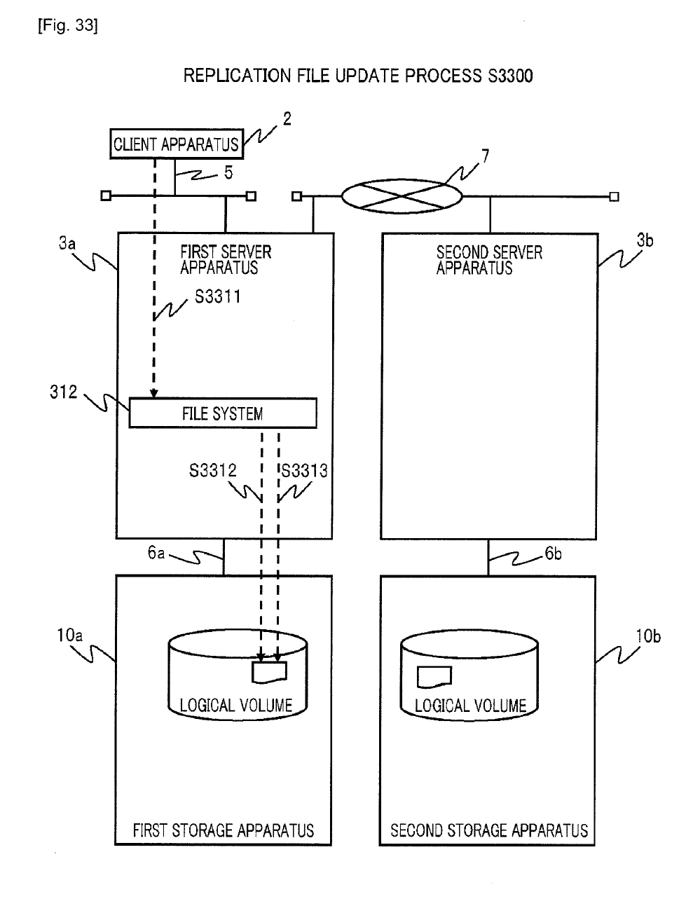

FIG. 31 illustrates processes that are performed by the information system 1 in order to actually stub the files selected as stub candidates at the stub candidate selection process S2900 (hereinafter, referred to as “stub process S3100”) (first migration). FIG. 32 illustrates a flowchart of details of the stub process S3100. The stub process S3100 is, for example, performed at predetermined timings (for example, right after the stub candidate selection process S2900 is performed). However, the timing for starting the stub process S3100 is not limited to the above. The stub process S3100 is described below with reference to these figures.

The first server apparatus 3a extracts one or more files that are selected as stub candidates (files whose stub flag 2611 is set at “1”), of the files being stored in the file storage area of the first storage apparatus 10a (S3111) (S3211, S3212).

The first server apparatus 3a deletes the entities of extracted files from the first storage apparatus 10a (S3213) and based on the meta data of the extracted file, sets an invalid value in the information indicating the file's storage destination of the first storage apparatus 10a (for example, NULL or zero is set in the field of the meta data in which the storage destination of the file is set (e.g., the setting field of the block address 2618) (S3214)). Then, the first server apparatus 3a stubs the files selected as stubbing candidates (S3112). At the same time, the first server apparatus 3a sets “1” in the meta data synchronization necessity flag 2612 (S3215).

<Replication File Update Process>

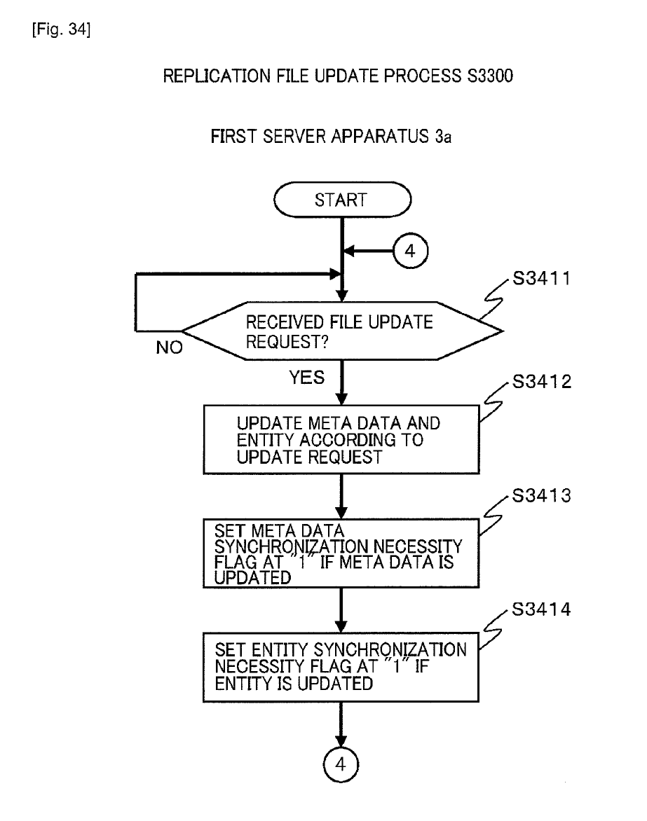

FIG. 33 illustrates processes that are performed by the information system 1 in a case where an update request to the replication files stored in the file storage area of the first storage apparatus 10a is received by the first server 3a from the client apparatus 2 (hereinafter, referred to as “replication file update process S3300”). FIG. 34 illustrates a flow chart of the replication file update process S3300. The replication file update process S3300 is described below with reference to these figures.

The first server apparatus 3a monitors on real time basis whether an update request to the replication files is received from the client apparatus 2 (S3411). When the first server apparatus 3a receives an update request to the replication files (S3311) (S3411: YES), the first server apparatus 3a updates the file data (meta data, entity) of the received replication file stored in the first storage apparatus 10a on the basis of the received update request (S3312) (S3412).

The first server apparatus 3a sets “1” in the meta data synchronization necessity flag 2312 of the replication file if the meta data is updated, and the first server apparatus sets “1” in the entity synchronization necessity flag 2313 of the replication file if the entity of the replication file is updated (S3313) (S3413, S3414).

<Replication File Reference Process>

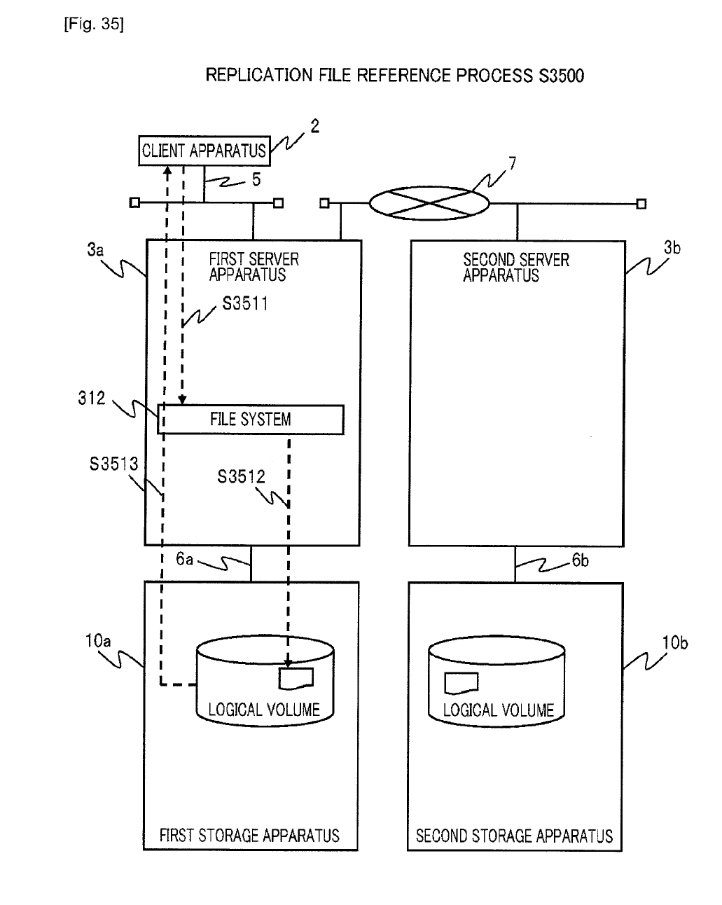

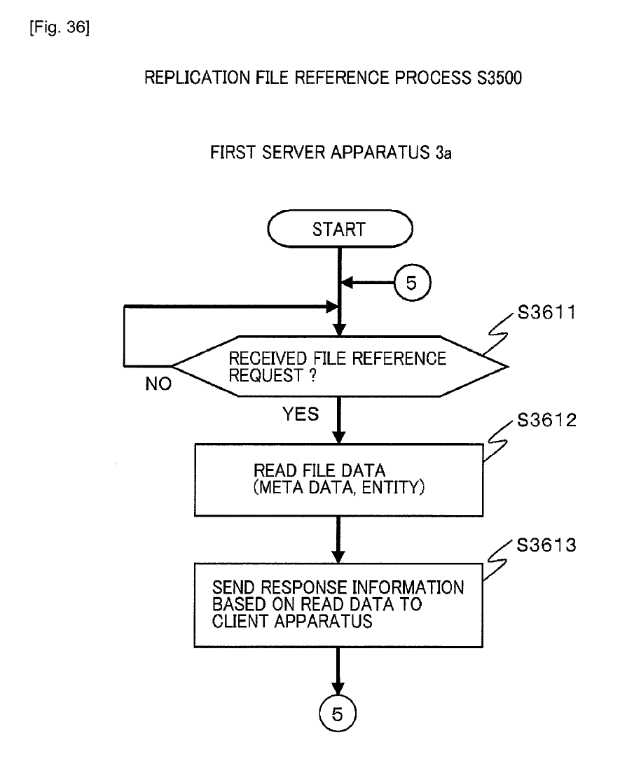

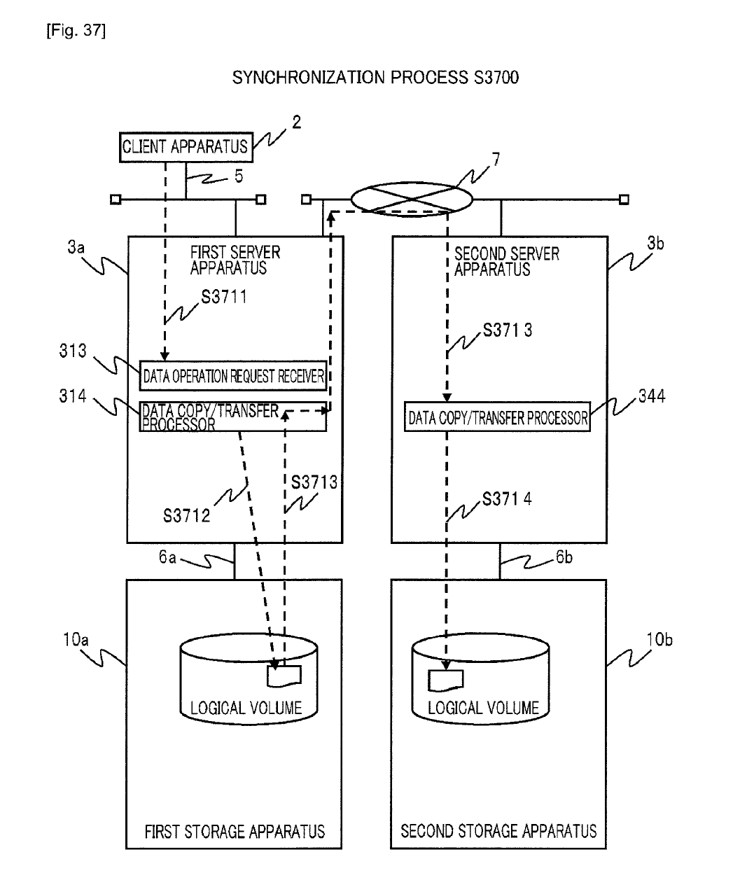

FIG. 35 illustrates processes that are performed by the information system 1 when the file system 312 of the first server apparatus 3a receives from the client apparatus 2 a reference request to replication files stored in the file storage area of the first storage apparatus 10a (hereinafter, referred to as “replication file reference process S3500”). FIG. 36 illustrates a flowchart of the replication file reference process S3500. The replication file reference process S3500 is described below with reference to these figures.

The first server apparatus 3a monitors on real time basis whether a reference request to a replication file is received from the client apparatus 2 or not (S3611). When the file system 312 of the first server apparatus 3a receives an update request of the replication file (S3511) (S3611: YES), the file system 312 reads the data (meta data or entity) of the replication file from the first storage apparatus 10a (S3512) (S3612), generates information for responding to the client apparatus 2 on the basis of the read data and sends the generated response information to the client apparatus 2 (S3513) (S3613).

<Synchronization Process>

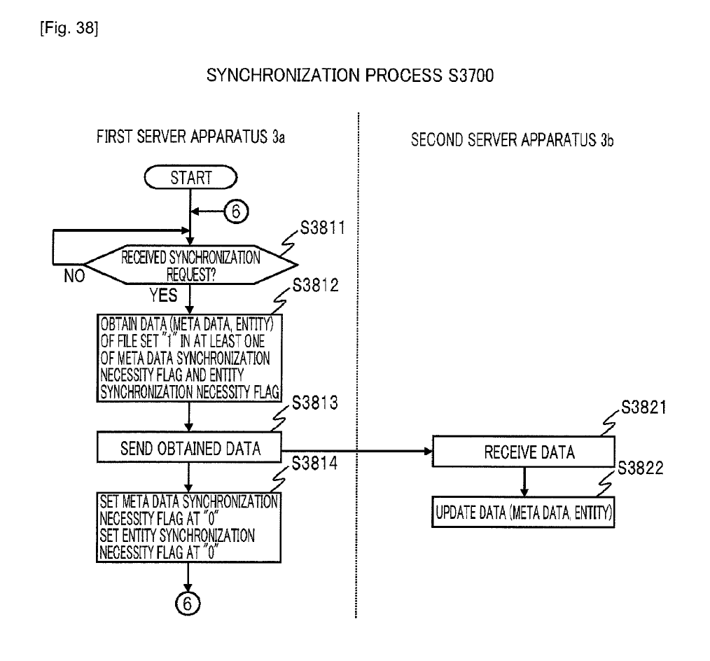

FIG. 37 illustrates processes that are performed in the information system 1 when a request, requesting that the content of the replication file stored in the first storage apparatus 10a be consistent with the content of the file of the second storage apparatus 10b, (hereinafter, referred to as “synchronization request”) is received from the client apparatus 2 (hereinafter, referred to as “synchronization process S3700”). FIG. 38 illustrates a flowchart of details of the synchronization process S3700. The synchronization process S3700 is described below with reference to these figures.

The synchronization process S3700 may be started at any timing other than timing of an event where a synchronization request is received from the client apparatus 2. For example, the synchronization process S3700 may be spontaneously started by the first server apparatus 3 at predetermined timing (real time, regular intervals, or the like).

The first server apparatus 3a monitors on a real time basis whether a synchronization request of a replication file is received from the client apparatus 2 or not (S3811). When the first server apparatus 3a receives a synchronization request of a replication file from the client apparatus 2 (S3711) (S3811: YES), the first server apparatus 3a obtains those files that have at least one of the meta data synchronization necessity flag 2612 or the entity synchronization necessity flag 2613 set at “1”, of the files stored in the file storage area of the first storage apparatus 10a (S3712) (S3812).

The first server apparatus 3a sends the meta data or entity of the obtained file to the second server apparatus 3b and sets “0” in the meta data synchronization necessity flag 2612 or the entity synchronization necessity flag 2613 (S3713) (S3814).

When the second server apparatus 3b receives the meta data or entity (S3713) (S3821), the second server apparatus 3b updates the meta data or the entity of the file, stored in the second storage apparatus 10b and corresponding to the received meta data or the entity, on the basis of the received meta data or entity (S3714) (S3822). The entire meta data or entity may not be necessarily sent from the first server apparatus 3a to the second server apparatus 3b, and only the differential data from the last synchronization may be sent.

By performing the synchronization process S3700 described above, the data (meta data or entity) of the file stored in the first storage apparatus 10a is synchronized with the data (meta data or entity) of the file stored in the second storage apparatus 10b.

<Meta Data Access Process>

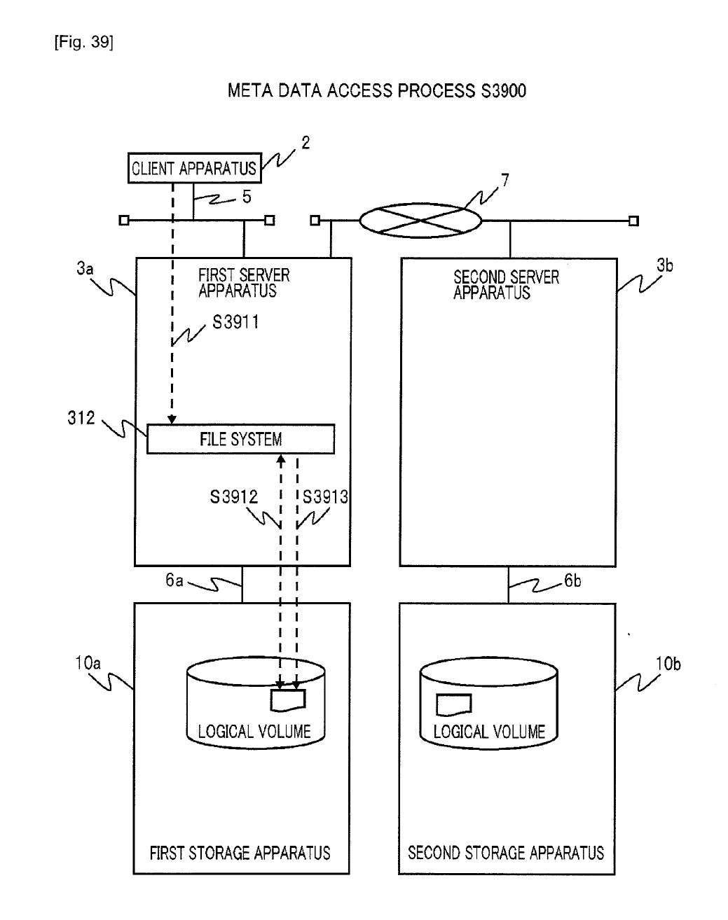

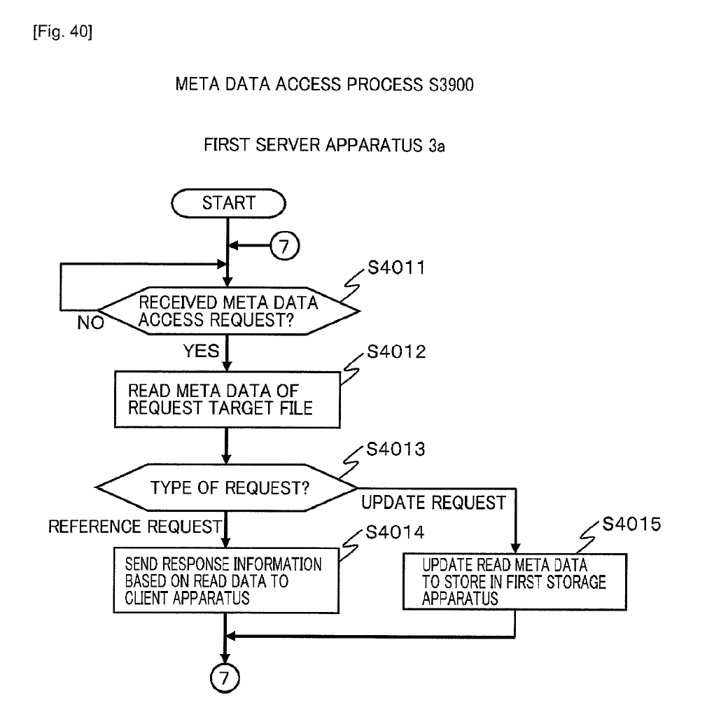

FIG. 39 illustrates processes that are performed by the information system 1 in a case where the file system 312 of the first server apparatus 3a receives an access request (reference request or update request) to the meta data of the stub file (the file whose stub flag is set at “1”) from the client apparatus 2 or the like (hereinafter, referred to as “meta data access process S3900”). FIG. 40 illustrates a flowchart of details of the meta data access process S3900. The meta data access process S3900 is described below with reference to these figures.

The first server apparatus 3a monitors on real time basis whether an access request (reference request or update request) to the meta data of stub file is received from the client apparatus 2 (S4011). When the first server apparatus 3a receives an access request to the meta data of the stub file (S3911) (S4011: YES), the first server apparatus 3a obtains the meta data of the first storage apparatus 10a specified by the received access request (S4012). According to the received access request (S4013), the first server apparatus 3a refers to the meta data (sends response information to the client apparatus 2 based on the meta data read) (S4014) or updates the meta data (S3912) (S4015). If the content of the meta data is updated (S4015), “1” is set in the meta data synchronization necessity flag 2612 of the file (S3913).

As described, if there is an access request to a stub file and the access request targets only the meta data of the file, the first server apparatus 3a handles the access request using the meta data stored in the first storage apparatus 10a. Therefore, a response can be quickly made to the client apparatus 2 in a case the access request targets only the meta data of the file.

<Stub File Entity Reference Process>

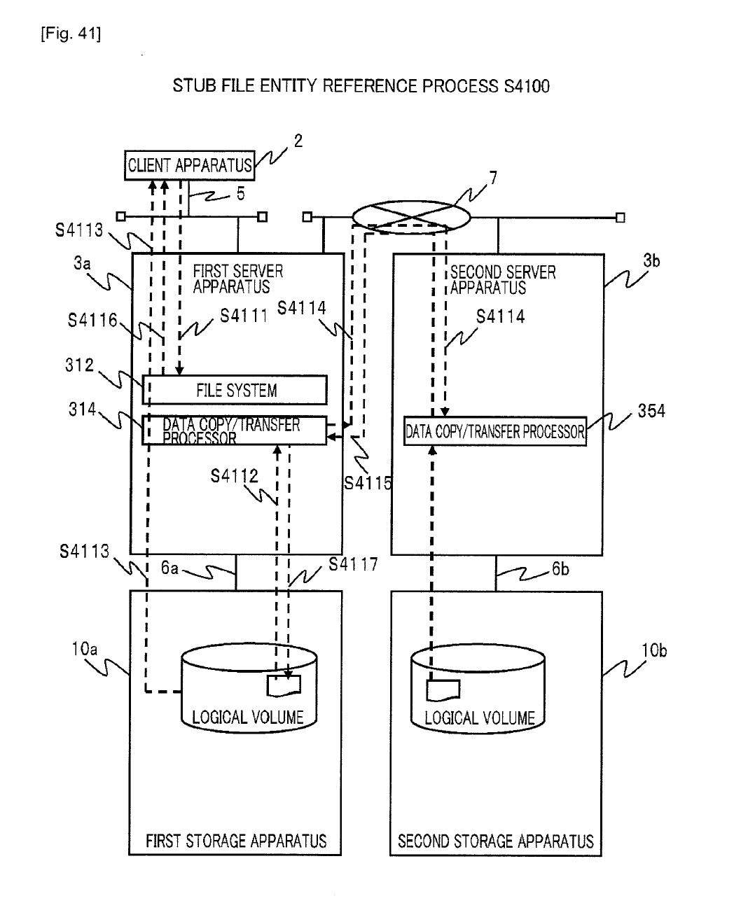

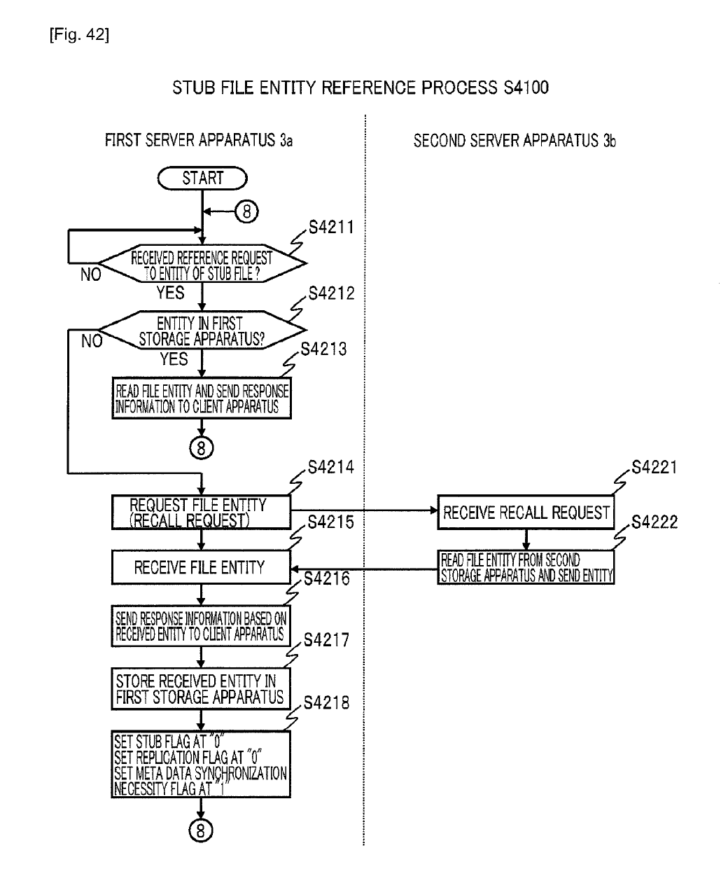

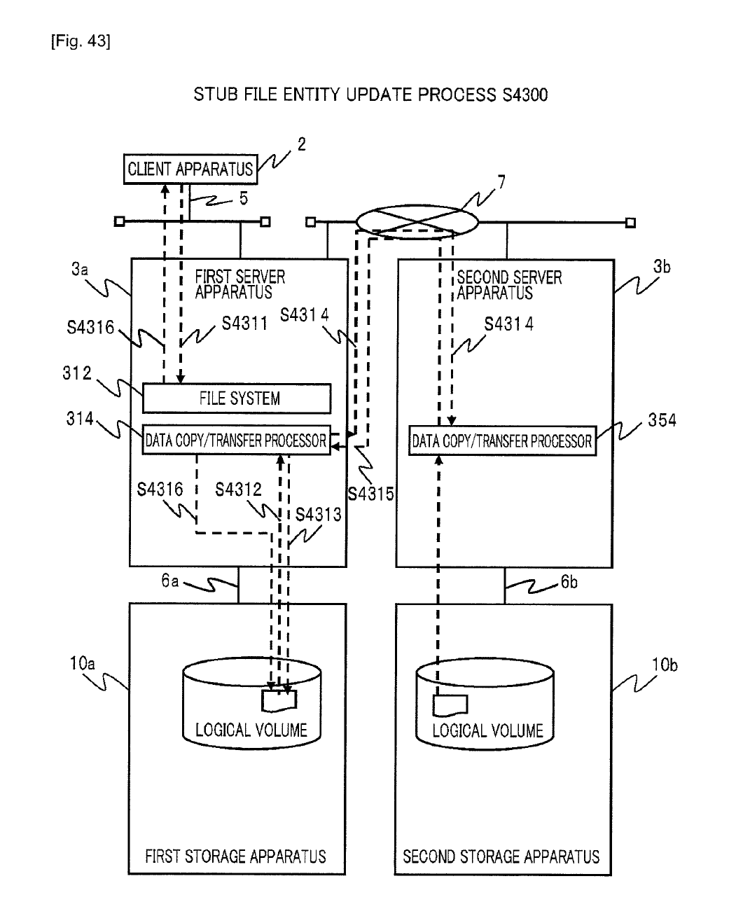

FIG. 41 illustrates processes that are performed by the information system 1 in case of an event where the first server apparatus 3a receives a reference request to the entity of the stubbed file (file whose stubbing flag 2311 is set at “1”, and hereinafter, referred to as “stubbed file”) (hereinafter, referred to as “stubbing file entity reference process S4100”). FIG. 42 illustrates a flowchart of details of the stubbing file entity reference process S4100. The stub file entity reference process S4100 is described below with reference to these figures.

When the first server apparatus 3a receives a reference request to the entity of the stub file (S4111) (S4211: YES), the first server apparatus 3a determines whether or not the entity of the stub file is stored in the first storage apparatus 10a (S4112) (S4212). The determination bases on, for example, as to whether a valid value indicating the storage destination of the entity of the stub file (e.g., block address 2618) is set in the obtained meta data or not.

If the entity of the stub file is stored in the first storage apparatus 10a (S4212: YES), the first server apparatus 3a reads the entity of the stub file from the first storage apparatus 10a, generates information that responds to the client apparatus 2 on the basis of the read entity, and sends the generated response information to the client apparatus 2 (S4113) (S4213).

If the entity of the stub file is not stored in the first storage apparatus 10a (S4212: NO), the first server apparatus 3a sends a request to the second server apparatus 3b for the entity of the stub file (hereinafter, referred to as “recall request”) (S4114) (S4214). The acquisition request of the entity does not necessarily request for the entire entity by a single acquisition request. For example, a part of the entity may be requested a plurality of times.

When the first server apparatus 3a receives the entity of the stub file from the second sever apparatus 3b in response to the acquisition request (S4221, S4222 and S4215) (S4115 in FIG. 41), the first server apparatus 3a generates response information based on the received entity and sends the generated response information to the client apparatus 2 (S4116) (S4216).

The first server apparatus 3a stores the entity received from the second server apparatus 3b in the first storage apparatus 10a, and sets contents indicating the storage destination of the first storage apparatus 10a of the file in the information of the meta data of the stub file that indicates the storage destination of the entity of the file (S4217).

The first server apparatus 3a sets “0” in the stub flag 2611 of the file, “0” in the replication flag 2614, and “1” in the meta data synchronization necessity flag 2612 (S4117) (S4218).

“1” is set in the meta data synchronization necessity flag 2612 as described above, whereby the stub flag 2311 and the replication flag 2314 of the stub file are automatically synchronized later in the first storage apparatus 10a and the second storage apparatus 10b.

<Stub File Entity Update Process>

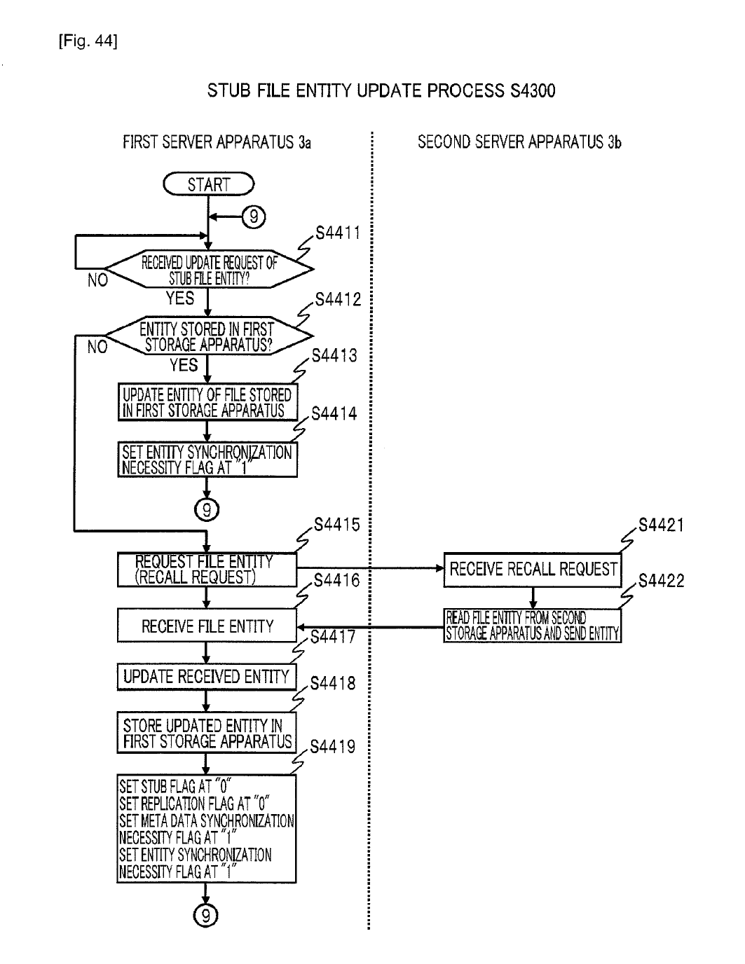

FIG. 43 illustrates processes that are performed in the information system 1 in a case the first server apparatus 3a receives an update request to the entity of the stub file (hereinafter, referred to as “stub file entity update process S4300”) from the client apparatus 2. Furthermore, FIG. 44 shows a flowchart of details of the stub file entity update process S4300. The stub file entity update process S4300 is described below with reference to these figures.

When the first server apparatus 3a receives an update request to the entity of the stub file from the client apparatus 2 (S4311) (S4411: YES), the first server apparatus 3a determines whether the entity of the stub file is stored in the first storage apparatus 10a (S4312) (S4412). The determination method is the same with the stub file entity reference process S4100.

If the entity of the stub file is stored in the first storage apparatus 10a (S4412: YES), the first server apparatus 3a updates the entity of the stub file stored in the first storage apparatus 10a on the basis of the contents of the update request (S4413) and sets “1” in the entity synchronization necessity flag 2613 of the stub file (S4313) (S4414).

If the entity of the stub file is not stored in the first storage apparatus 10a as a result of the determination above (S4412: NO), the first server apparatus 3a sends an acquisition request (recall request) of the stub file to the second server apparatus 3b (S4314) (S4415).

When the first server apparatus 3a receives the entity of the file sent from the second server apparatus 3b in response to the request (S4315) (S4421, S4422, S4416), the first server apparatus 3a updates the content of the received entity on the basis of the update request (S4417), and stores the post-update entity in the first storage apparatus 10a as the entity of the stub file (S4316) (S4418).

The first server apparatus 3a sets “0” in the stub flag 2611 of the stub file, “0” in the replication flag 2614, “1” in the meta data synchronization necessity flag 2612, and “1” in the entity synchronization necessity flag (S4419).

=Second Migration=

The following describes the processes performed between the first server apparatus 3a (file storage apparatus) and the third server apparatus 3c (NAS apparatus) in the edge 50.

The data stored in the third server apparatus 3c (third storage apparatus 10c) is migrated into the first server apparatus 3a (first storage apparatus 10a) in a sequential and on-demand manner (second migration). This on-demand migration is performed in a manner such that the directory image (, which is configuration information of the directory such as data indicating a hierarchical structure of the directory, directory data (meta data), file data (meta data or entity) and the like) of the third server apparatus 3c is previously migrated into the first server apparatus 3a in a state of partly stubbed images (for example, image of a root directory). Further, when the data I/O request is received by the first server apparatus 3a from the client apparatus 2, the entity of the stub directory or entity is sent (recalled) from the third server apparatus 3c to the first server apparatus 3a.

<Directory Image Pre-migration Process>

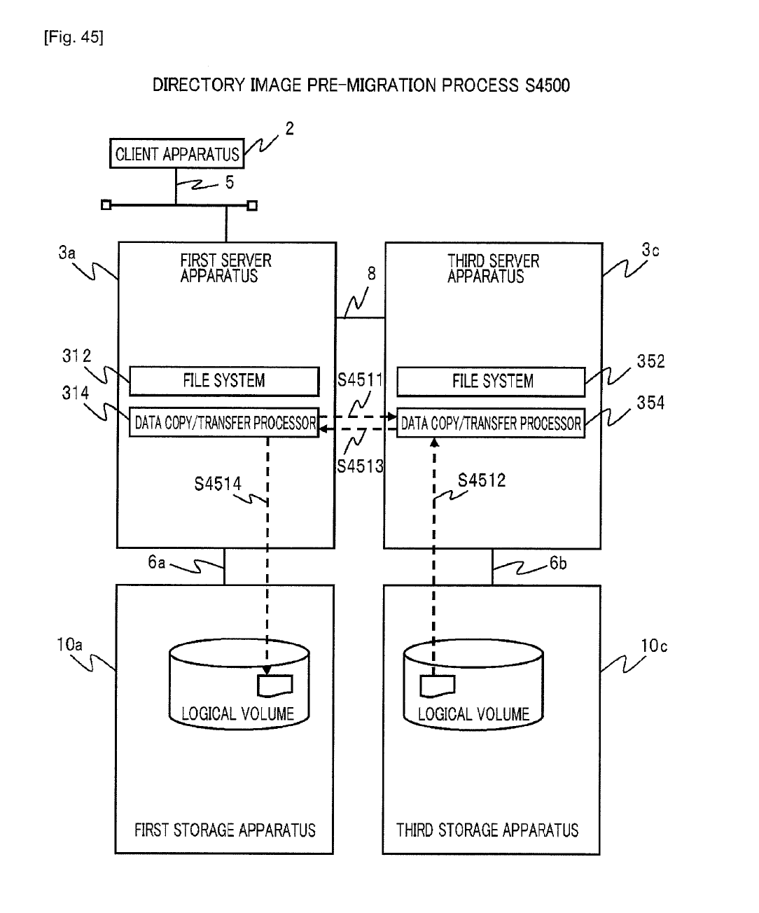

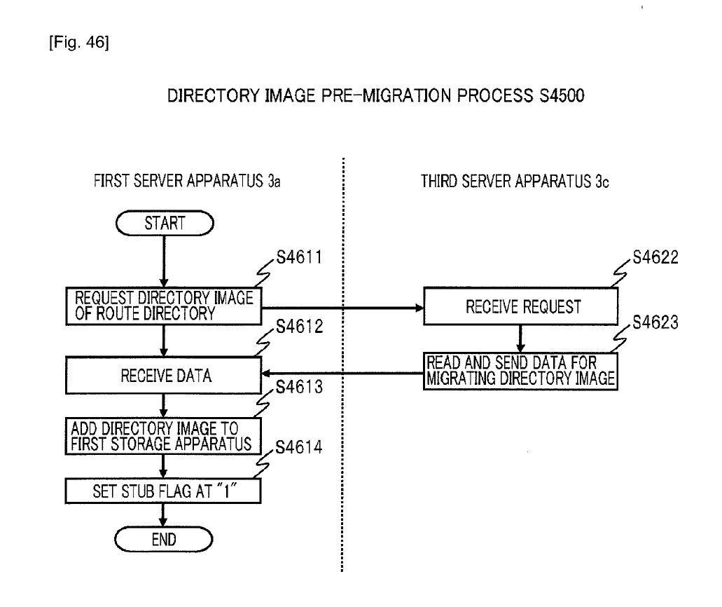

FIG. 45 illustrates processes performed by the first server apparatus 3a (first storage apparatus 10a) and the third server apparatus 3c (third storage apparatus 10c) upon the migration of the directory image (hereinafter, referred to as “directory image premigration process S4500”). FIG. 46 illustrates a flowchart of details of the directory image pre-migration process S4500. The following description is made with reference to these figures.

To begin with, the first server apparatus 3a sends the meta data of a directory located in the route directory and an acquisition request of meta data of a file located in the route directory to the third server apparatus 3c (S4511) (S4611). In the present embodiment, in a case of the meta data of the directory in the route directory or the meta data of the file in the route directory, a directory and file in the route directory is included but does not include the directory that is located under the route directory nor files in this directory.

When the third server apparatus 3c receives the acquisition request (S4622), the third server apparatus 3c obtains from the third storage apparatus 10c the meta data of the directory located in the route directory and the meta data of the file located in the route directory being requested and then sends the obtained meta data to the first storage apparatus 10a (S4513) (S4623).

When the first server apparatus 3a receives the meta data from the third server apparatus 3c (S4513) (S4612), the first server apparatus 3a adds a directory image to the file system 312 on the basis of the received meta data (S4514) (S4613). At the same time, the first server apparatus 3a sets “1” in the stub flag 2611 of the added directory image (S4614).

<On-demand Migration Process>

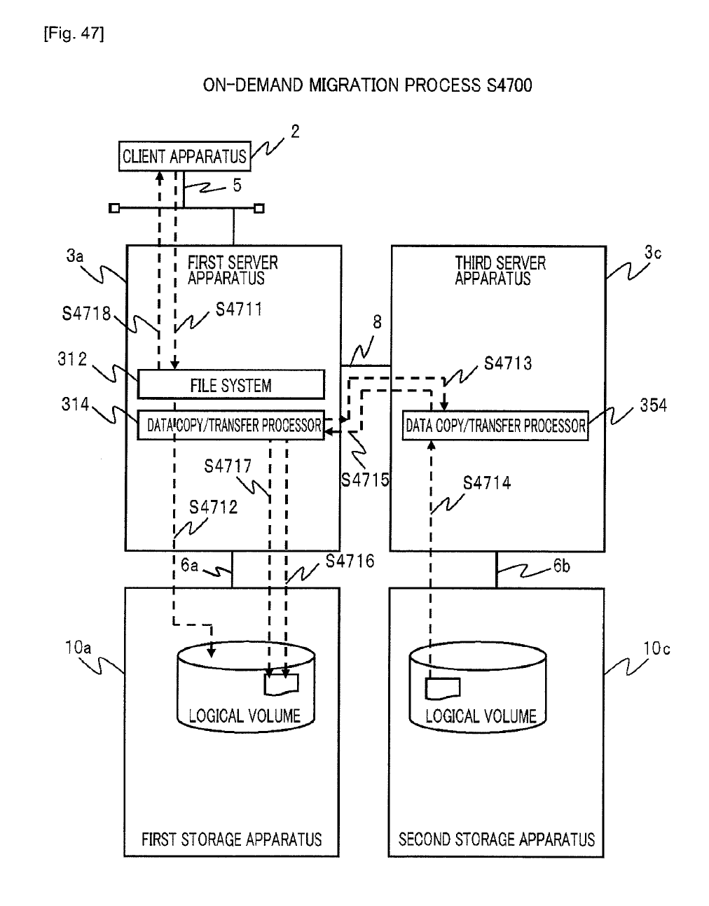

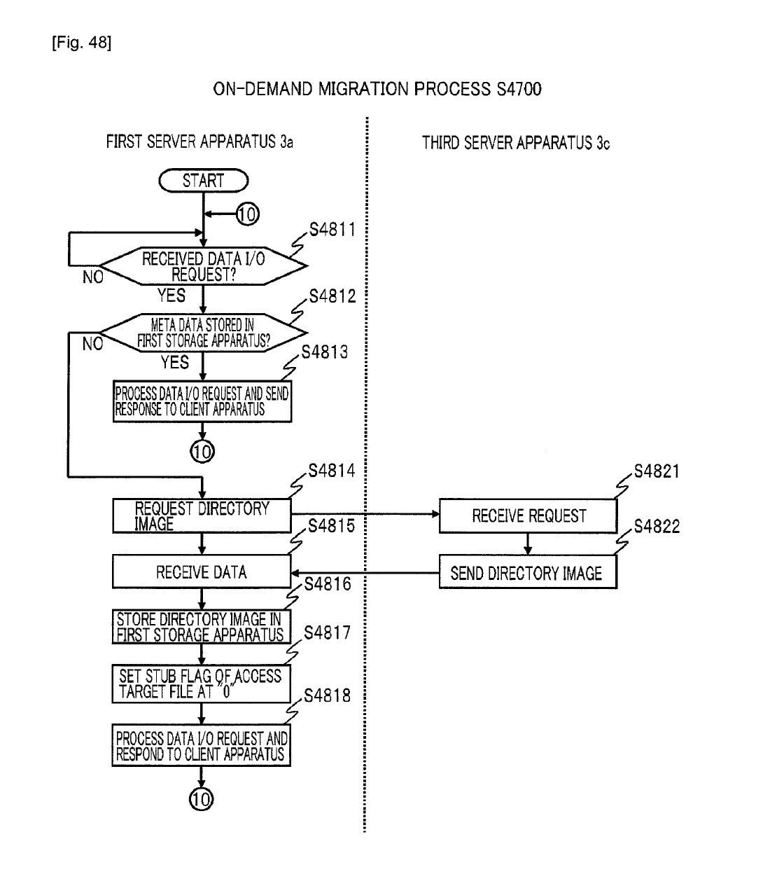

FIG. 47 illustrates processes by which the entity of the stub directory or file is sent (recalled) from the third server apparatus 3c to the first server apparatus 3a in case of an event where the first server apparatus 3a receives a data I/O request from the client apparatus 2 (hereinafter, referred to as “on-demand migration process S4700”) (second migration). FIG. 48 illustrates a flowchart of details of the on-demand migration process S4700. As the on-demand migration process S4700 is performed, the data of the third server apparatus 3c (third storage apparatus 10c) is migrated into the first server apparatus 3a (first storage apparatus 10a) in an on-demand manner. The following description is made with reference to these figures.

When the first server apparatus 3a receives a data I/O request from the client apparatus 2 (S4711) (S4811: YES), the first server apparatus 3a checks whether the meta data of the directory or file being a target of the received I/O data request (hereinafter, referred to as “access target”) is stored in the first storage apparatus 10a (S4712) (S4812).

If the meta data of the directory or file of the access target is migrated into the first storage apparatus 10a (S4812: YES), the first server apparatus 3a performs processes for to the received data I/O request on the basis of the target, type, management method, necessity to stub and the like of the received data I/O request and responds to the client apparatus 2 (S4718) (S4813).

If the meta data of the access target is not migrated into the first storage apparatus 10a (S4812: NO), the first server apparatus 3a sends a request to the third server apparatus 3c for the directory images covering the area starting from the route directory up to the directory level where the access target exists (S4713) (S4814).

When the third server apparatus 3c receives the above-mentioned request (S4821), the third server apparatus 3c obtains the requested directory image from the third storage apparatus 10c and then sends the obtained directory image to the first server apparatus 3a (S4715) (S4822).

When the first server apparatus 3a receives the directory image from the third server apparatus 3c (S 1715) (S4815), the first server apparatus 3a stores the received directory image in the first storage apparatus 10a (S4716) (S4816). The first server apparatus 3a sets “0” in the stub flag 2611 of the access target and responds to the client apparatus 2 (S4717) (S4817).

The first server apparatus 3a performs the processes corresponding to the received data I/O request (S4718) (S4818).

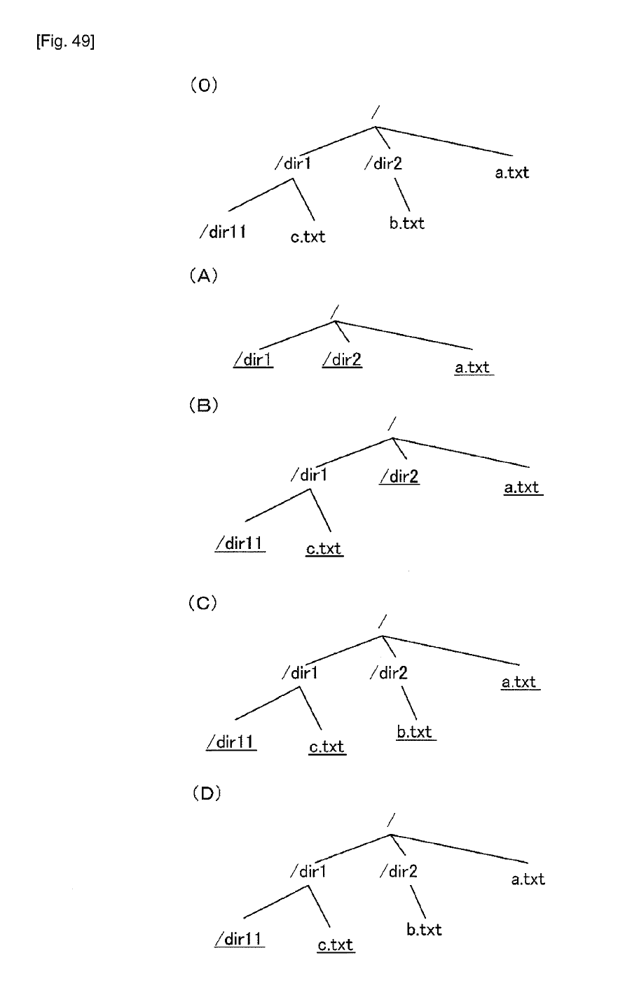

FIG. 49 illustrates how the directory image sequentially migrates into the first server apparatus 3a (first storage apparatus 10a) by repeatedly performing the on-demand migration process S4700 described above.

In FIG. 49, directories indicated by highlighted strings (the underlined strings) are ones whose meta data has been migrated but the meta data of its lower-level directories are not. Directories indicated by non-highlight strings are ones where the meta data of its lower-level directories has also been migrated. Files indicated by highlighted strings are ones whose meta data has been migrated but its entity is not. Files indicated by non-highlight strings are ones whose entity has also been migrated.

FIG. 49 (O) illustrates a directory image (the entire directory image that is migrated in the end) that has been managed in the first server apparatus 3a (first storage apparatus 10a) just before an error occurs.

FIG. 49 (A) illustrates a directory image right after the directory image pre-migration process S4500 (i.e., before the data I/O request is received from the first server apparatus 3a). As illustrated in FIG. 49, at this stage, the meta data of the directories “/dir1” and “/dir2” located right under the route directory “/” has been migrated but the meta data under these directories are not migrated yet. Further, the meta data of the file “a.txt” right under the route directory “/” has been migrated but the entity of the file is not migrated yet.

FIG. 49 (B) illustrates a status after a data I/O request to the file “c.txt” located under the directory “/dir1” is received at the state of (A) from the client apparatus 2. As the data I/O request to the file “c.txt” is received from the client apparatus 2, the meta data of the directory “/dir11” and the meta data of the file “/c.txt” are migrated.

FIG. 49 (C) illustrates a status after a data I/O request to the file “b.txt” located under the directory “/dir2” is further received at the status of (B) from the client apparatus 2. As the data I/O request to the file “b.txt” is received from the client apparatus 2 as illustrated in FIG. 49, the meta data of the file “/b.txt” is migrated. Since the meta data of the file “/b.txt” located under the directory “/dir2” is migrated, the directory “/dir2” is indicated by a non-highlight string.

FIG. 49 (D) illustrates a status after a data I/O request (update request) to the file “b.txt” is received at status (C) from the client apparatus 2. As the data I/O request (update request) to the file “b.txt” is received from the client apparatus 2, the entity of the file “b.txt” is migrated.

As described above, data migration from the third server apparatus 3c (third storage apparatus 10c) to the first server apparatus 3a (first storage apparatus 10a) is performed step by step in an on-demand manner. When the data is migrated in an on-demand manner as described above, the first server apparatus 3a (first storage apparatus 10a) can start providing services to the client apparatus 2 without waiting for the completion of migration of all data from the third server apparatus 3c (third storage apparatus 10c) to the first server apparatus 3a (first storage apparatus 10a).

=Efficient Use of Physical Resource=

When the first server apparatus 3a uses the virtual LU provided with Thin Provisioning function of the first storage apparatus 10a, the directory image migrated (from the third server apparatus 3c to the first server apparatus 3a) by the on-demand migration process S4700 (S4716) (S4816) is stored in the virtual LU.

The files stored in the virtual LU of the first storage apparatus 10a may be selected as stub candidates at the stubbing candidate selection process S2900 (S2911) (S3013). Therefore, the file whose entity has been migrated by the on-demand migration process S4700 may be selected as a stub candidate early (in a short period of time) after the migration (S2911) (S3013) and then be stubbed (the entity is deleted from the first storage apparatus 10a) (S3112) (S3213).

When the entity of the file is stored in the virtual LU by the on-demand migration process S4700 described above, a new page is assigned to the virtual LU from the storage pool. However, if a page is assigned from the storage pool for the entity of the file that is stubbed early (S3112) (S3213) after the migration into the first storage apparatus 10a, a large amount of the data blocks that are assigned but unused (hereinafter, referred to as “assigned-unused area”) are generated, whereby the physical resource (page) of the first storage apparatus 10a is wasted.

In view of the above, when the entity of the file is migrated (from the third server apparatus 3c to the first server apparatus 3a) (S4716) (S4816) at the on-demand migration process S4700 in the information system 1 according to the present embodiment, the information system 1 determines whether the file is likely to be stubbed early (S3112) (S3213) or not. For the file likely to be stubbed early, the information system 1 positively stores the entity of the file in the assigned-unused area. In this way, the assignment of a new page to the virtual LU can be suppressed upon the migration of a file, whereby the physical resource can be used efficiently.

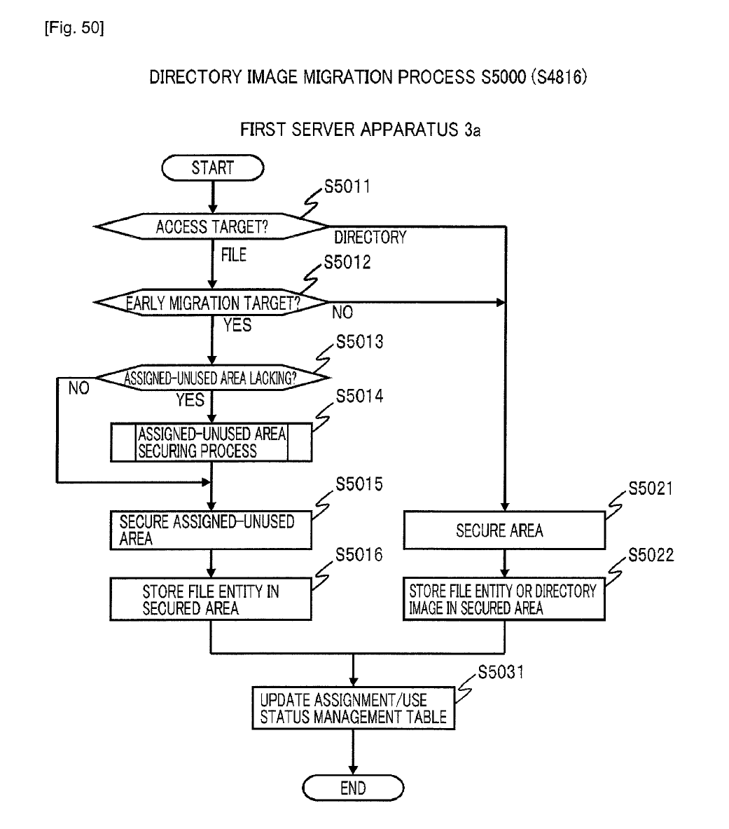

FIG. 50 illustrates a flowchart of the process S4816 of FIG. 48 (S4716 of FIG. 47) in a case where the above-mentioned processes are performed (hereinafter, referred to as “directory image migration process S5000”). The description below is made with reference to the figure.

To begin with, the first server apparatus 3a determines whether the target of the data I/O request (access target) received at S4811 is a file or a directory (S5011). If the access target is a file (S5011: File), the process proceeds to S5012. If the access target is a directory (S5011: Directory), the process proceeds to S5021. For example, as a case the access target is the directory, there is a case where the data I/O request is a command requesting for configuration information of a directory.

At S5012, the first server apparatus 3a determines whether the file of the access target is a file that is likely to be stubbed early (S3112) (S3213) or not (hereinafter, referred to as “early migration target file”). If the file of the access target is an early migration target file (S5012: YES), the process proceeds to S5013. If the file of the access target is not an early migration target file (S5012: NO), the process proceeds to S5021. Determining as to whether the file of the access target is the early migration target file or not is performed by checking whether the file is included in an early migration target file list 334 that is outputted at the early migration target extraction process S5200 described later.

At S5013, the first server apparatus 3a refers to the assignment/use status management table 333 and determines whether a sufficient amount of an assigned-unused area, for storing the entity of the access target, can be secured or not. If a sufficient amount of the assigned-unused area for storing the entity of the access target can be secured (S5013: NO), the procedure proceeds to S5015. If a sufficient amount of the assigned-unused area for storing the entity of the access target cannot be reserved (i.e., if the assigned-unused area is lacking) (S5013: YES), the process proceeds to S5014.

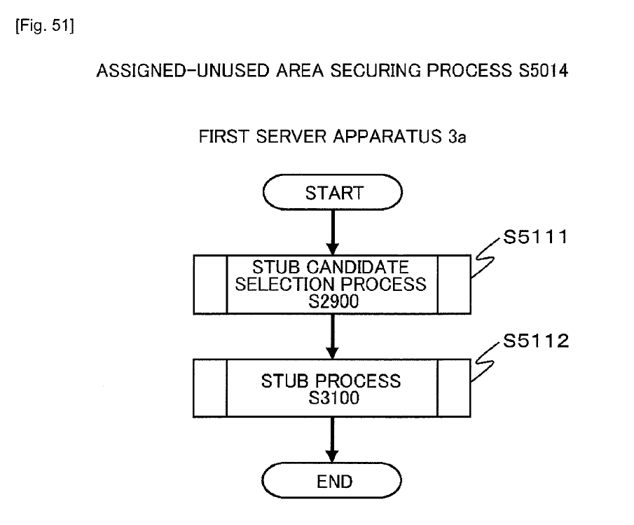

At S5014, the first server apparatus 3a performs processes to secure the assigned-unused area. FIG. 51 illustrates an example of this process (hereinafter, referred to as “assigned-unused area securing process S5014). In this example, the file managed in the first server apparatus 3a (first storage apparatus 10a) is positively stubbed to secure the assigned-unused area.

As illustrated in FIG. 51, the first server apparatus 3a performs the stub candidate selection process S2900 described above (S5111) and then performs the stub process S3100 (S5112). If the assigned-unused area is lacking, the file satisfying a certain condition is positively stubbed to make an assigned-unused area. Thus, new allocation of physical resource to the virtual LU is prevented, whereby the physical resource is used efficiently.

Referring back to FIG. 50, at S5015, the first server apparatus 3a refers to the assignment/use status management table 333 and secures (allocates) an assigned-unused area that is to be the storage destination of the entity of the access target. If a sufficient amount of assigned-unused area for storing the entity of the access target cannot be secured even if the assigned-unused area securing process at S5014 is performed, an unassigned area (data block whose unassigned area flag 3335 is set at “1”) is secured to compensate for the lacking amount.

At S5016, the first server apparatus 3a stores the entity of the file in the area secured at S5015. The process then proceeds to S5031.

At S5021, the first server apparatus 3a secures an area (data block) that is used as a storage destination of the directory image of the access target directory or the entity of the access target file. The reserved area described above may be an unassigned area or assigned-unused area. The first server apparatus 3a stores the directory image of the access target directory or the entity of the access target file in the reserved area. The procedure then proceeds to S5031.

At S5031, the first server apparatus 3a updates contents of the assignment/use status management table 333 so that the contents reflect the status after the directory image of the access target directory or the entity of the access target file is stored.

<Extraction of Early Migration Target File>

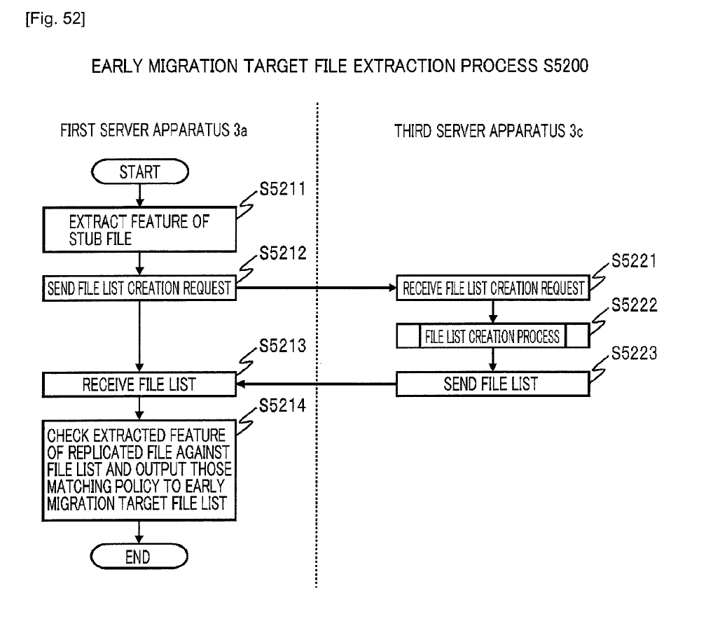

The following describes the processes relating to the creation the early migration target file list 334 described above that is referred by the first server apparatus 3a in order to determine whether the access target file is an early migration target file or not at S5012 of FIG. 50 (hereinafter, referred to as “early migration target file extraction process S5200”). FIG. 52 illustrates a flowchart of the early migration target file extraction process S5200. Description below is made with reference to the figure.

To begin with, the first server apparatus 3a refers to the inode management table 2212 of the file system 312 and extracts features of the stub file (file whose stub flag 2611 is set at “1”) (S5211). The features of the file are, for example, file name, extension, size, update date and time, owner, access right and the like. The extraction of feature may focus on the extraction of features only with high occurrence frequency (feature whose occurrence frequency is equal to or higher than a predetermined threshold value).

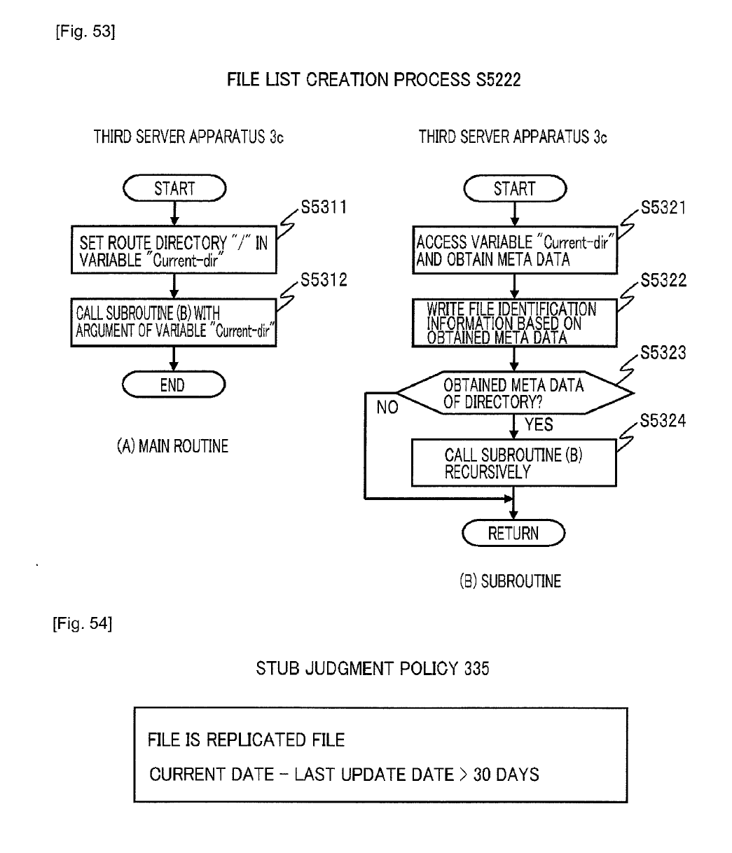

The first server apparatus 3a sends a request for creation of a list of files stored in the third server apparatus 3c (hereinafter, referred to as “file list”) (S5212). When the third server apparatus 3c receives the above request (S5221), the third server apparatus 3c starts creating the file list (S5222). FIG. 53 illustrates a flowchart of processes that are performed at this stage (hereinafter, referred to as “file list creation process S5222”).

As illustrated in the flowchart (A) of the main routine, the third server apparatus 3c sets an identifier (e.g., “/”) of the route directory of the file system 352 in the variable “current-dir” as an initial value (S5311). And this identifier is used as an argument to call the subroutine identified with (B).

In subroutine (B), the third server apparatus 3c accesses the directory that is specified by an argument received from a caller (main routine or subroutine) and obtains the meta data of the file or the meta data of the directory located under the directory (S5321) and then outputs the identification information of the file based on the obtained meta data to the write file (S5322).

Then, the third apparatus 3c determines whether the meta data of the directory has been obtained at S5321 or not (S5323). If the meta data of the directory has been obtained (S5323: YES), the third server apparatus 3c sets the directory in the variable “Current-dir” and uses this as an argument to call the subroutine recursively (S5324). If the meta data of the directory has not been obtained at S5321 (S5323: NO), the process returns to the caller (main routine (A) or subroutine (B)).

The list of files stored in the third server apparatus 3c, i.e., file list, is outputted to the write file as described above.

Referring back to FIG. 52, at S5223, the third server apparatus 3c sends the file list that has been created at S5222 to the first server apparatus 3a. When the first server apparatus 3a receives the file list (S5213), the first server apparatus 3a checks the received file list against the features of files extracted at S5211, selects the files, of the files in the file list, that match (or are similar to) the features of files extracted at S5211 and that satisfy the stub condition, and then outputs the same as the early migration target file list 334 (an example is illustrated in FIG. 58) (S5214). Whether the stubbing condition is satisfied or not is determined based on, for example, whether conditions defined by the predetermined policy (hereinafter, referred to as “stub judgment policy 335”) are met or not. FIG. 54 illustrates an exemplary stub judgment policy 335.

As described above, the first server apparatus 3a extracts files whose entity is to be stored in the assigned-unused area on the basis of features of stubbed (first migration) files, which definitely enables the identification of files that are likely to be migrated (first migration) early to the second server apparatus 3b (second storage apparatus 10b) by the on-demand migration process S4700 after the migration (second migration) from the third server apparatus 3c (third storage apparatus 10c) to the first server apparatus 3a (first storage apparatus 10a).

As described above, the files that are likely to be migrated (first migration) early to the second server apparatus 3b (second storage apparatus 10b) by the on-demand migration process S4700 are identified on the basis of the features of stubbed (first migration) files and at the same time, determined whether or not the files satisfy the conditions defined in the predetermined policy to output to the early migration target file list 334. Alternatively, whether the files meet the conditions of a predetermined policy or not may be checked and the files meeting the conditions may be outputted to the early migration target file list 334.

<Migration Process with Batch>

At the on-demand migration process S4700 illustrated in FIGS. 47 and 48, the first server apparatus 3a receives a data I/O request from the client apparatus 2, and then the directory image is sequentially migrated into the first server apparatus 3a (first storage apparatus 10a). Alternatively, a pseudo data I/O request may be generated in the first server apparatus 3a, and the directory image may be migrated into the first server apparatus 3a (first storage apparatus 10a) with batch processes. In this case, the directory image may be immediately migrated into the first server apparatus 3a (first storage apparatus 10a) without waiting for the data I/O request from the client apparatus 2.

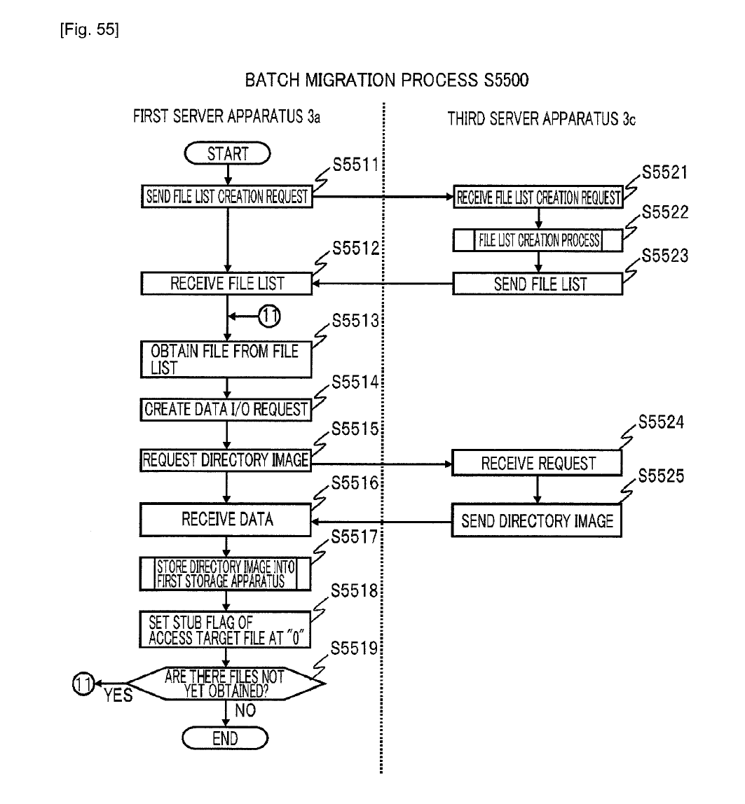

FIG. 55 illustrates a flowchart of processes that are performed by the first server apparatus 3a and the third server apparatus 3c when directory images are migrated into the first server apparatus 3a (first storage apparatus 10a) with batch processes by generating a pseudo data I/O request in the first server apparatus 3a (hereinafter, referred to as “batch migration process S5500”).

As illustrated in FIG. 55, first server apparatus 3a sends to the third sever apparatus 3c a request for creating a list of files (hereinafter, referred to as “file list”) that are stored in the third server apparatus 3c (S5511). When the third server apparatus 3c receives the above-mentioned request (S5521), the third server apparatus 3c starts creating a file list (S5522). The creation of the file list is performed in the same way as the file list creation process S5222 (FIG. 53).

At S5523, the third server apparatus 3c sends the file list created at S5522 to the first server apparatus 3a. When the first server apparatus 3a receives the file list (S5512), the first server apparatus 3a obtains one or more files from the file list (S5513) and creates the data I/O request targeting the obtained file (hereinafter, referred to as “access target”) (S5514).

The first server apparatus 3a sends a request to the third server apparatus 3c for the directory image that leads from the route directory, being the origination, to the directory level of the access target (S5515).

When the third server apparatus 3c receives the request (S5524), the third server apparatus 3c obtains the requested directory image from the third storage apparatus 10c and sends the obtained directory image to the first server apparatus 3a (S5525).

Upon reception of the directory image from the third server apparatus 3c (S5516) the first server apparatus 3a stores the received directory image into the first storage apparatus 10a (S5517).

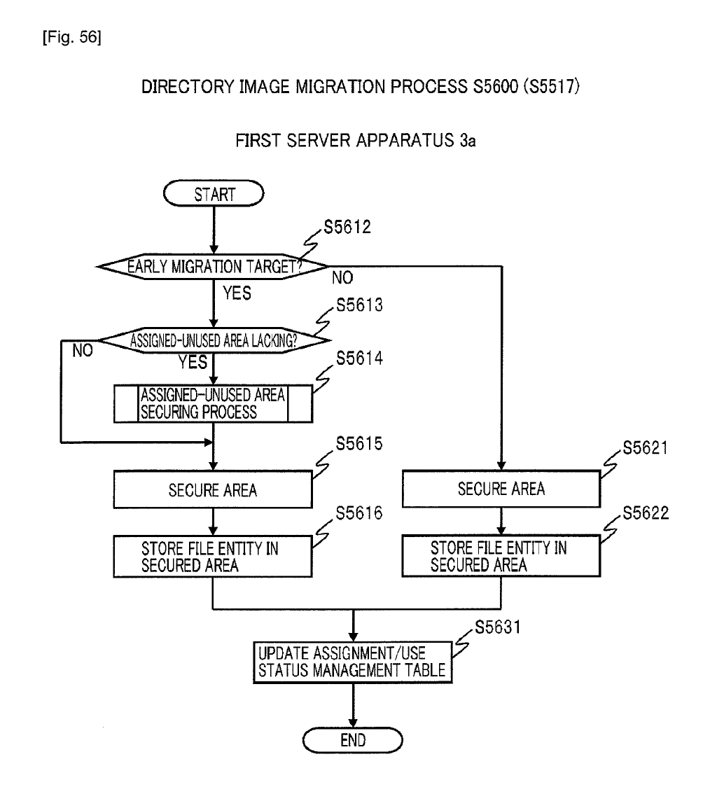

FIG. 56 illustrates a flowchart of details of the process S5517. To begin with, the first server apparatus 3a determines whether the access target file is an early migration target file or not (S5612). If the access target file is an early migration target file (S5612: YES), the process proceeds to S5613. If the access target file is not an early migration target file (S5612: NO), the process proceeds to S5621. Determining as to whether the access target file is an early migration target file or not is performed by checking whether the access target file is included in the early migration target file list 334 that is outputted at the early migration target extraction process S5200.

At S5613, the first server apparatus 3a refers to the assignment/use status management table 333 and determines whether a sufficient amount of assigned-unused area for storing the access target entity can be secured or not. If a sufficient amount of assigned-unused area for storing the access target entity can be secured (S5613: NO), the process proceeds to S5615. If a sufficient amount of assigned-unused area for storing the access target entity cannot be secured (S5613: YES), the process proceeds to S5614.

At S5614, the first server apparatus 3a performs processes to secure the assigned-unused area. The process is, for example, similar to the assigned-unused area securing process S5014 described above.

The first server apparatus 3a refers to the assignment/use status management table 333 and secures (allocates) the assigned-unused area that is to be used as the storage destination of the access target entity (S5615). If there is a data block whose transfer area flag 3336 is set at “1”, the first sever apparatus preferentially secures the data block as the storage destination of the access target entity.

The setting of the transfer area flag 3336 is, for example, manually performed by a user with support of a user interface provided by the first server apparatus 3a as described above. For example, when a file list is received from the third serer apparatus 3c (S5512), the first server apparatus 3a may automatically set “1” in the transfer area flag 3336 of the data block of the size that amounts to the data size of the migration target file estimated based on the received file list. As described, the assigned-unused area for storing the entity of the file is previously secured, whereby the obtained entity can be definitely stored in the assigned-unused area and therefore the physical resource can be efficiently used. If a sufficient amount of assigned-unused area for storing the access target entity cannot be secured even with the execution of the assigned-unused area reserving process S5614, an unassigned area (data block whose unassigned area flag 3335 is set at “1”) is secured to compensate for the lacking part.

The first server apparatus 3a stores the entity of the file in the area secured at S5615. The process then proceeds to S5631.

At S5621, the first serer apparatus 3a secures the directory image of the access target directory and an area (data block) as a storage destination of the file entity of the access target. The area to be reserved may be an unassigned area or assigned-unused area. The first server apparatus 3a stores the file entity of the access target in the secured area. The process then proceeds to S5631.

At S5631, the first server apparatus 3a updates contents of the assignment/use status management table 333 so that the contents reflect the status after the directory image of the access target directory or the entity of the access target file is stored.

Referring back to FIG. 55, the first server apparatus 3a sets “0” in the stub flag 2611 of the access target (S5518).

Next, at 5519, the first server apparatus 3a determines whether there is a file that is not yet obtained from the file list at S5513 or not. If there is a file that is not obtained yet (S5519: YES), the process returns to S5513. If there is no file that is not obtained yet (S5519: NO), the process ends.

<Use Limitation of Assigned-unused Area>

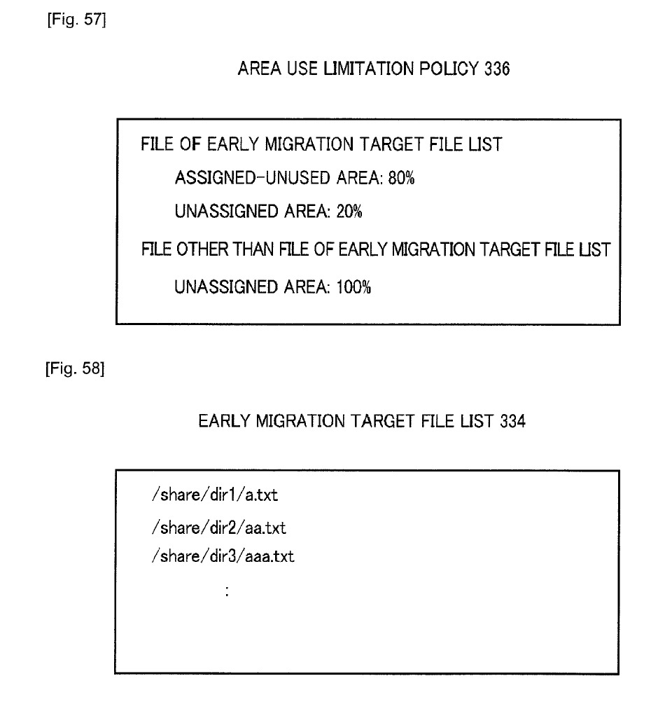

At the directory image migration process S5000 described above or the directory image migration process S5600 described above, an available assigned-unused area as the storage destination of the early migration target file may be limited. In this case, for example, the policy illustrated in FIG. 57 or the like (hereinafter, referred to as “area use limitation policy 336”) is set in advance and stored in the first server apparatus 3a. When the first server apparatus 3a performs process S5015 of the directory image migration process S5000 or process S5615 of the directory image migration process S5600, the area to be used as the storage destination of the early migration target file is secured according to the area use limitation policy 336.

The policy illustrated in FIG. 57 defines a rule where, for the storage destination of the early migration target file, 80% (upper limit) uses the assigned-unused area while the remaining 20% uses the unassigned area (data block whose unassigned area flag 3335 of the assignment/use status management table 333 is set at “1”) (therefore, a new page into the virtual LU is allocated for this amount). As for the files other than the files of the early migration target file list 334, there is a rule such that 100% uses the unassigned area.

In this manner, the timing when the assigned-unused area runs out can be postponed.

Thus, frequent allocation of a page to the virtual LU due to the depletion of the assigned-unused area can be prevented, whereby decline in performance of the first server apparatus 3a and the first storage apparatus 10a can be prevented.

Although the present embodiment has been described above, the above embodiment is for the convenience of understanding the present invention and does not intend to limit the interpretation of the present invention. The present invention may be changed or modified without departing from the scope of the invention and includes equivalent

1. A server apparatus in an information system comprising
a first server apparatus that includes a file system and receives a data I/O request transmitted from an external apparatus to perform data I/O to a first storage apparatus,
a second server apparatus that is communicatively coupled to the first server apparatus and performs data I/O to a second storage apparatus, and
a third server apparatus that is communicatively coupled to the first server apparatus and performs data I/O to a third storage apparatus, the first storage apparatus providing the first server apparatus with a virtual volume being a virtual storage area provided by Thin Provisioning, wherein the first server apparatus
performs as needed a first migration, by which an entity of a file, of files stored in the first storage apparatus, satisfying a predetermined condition is migrated into the second storage apparatus,
performs as needed a second migration, by which an entity of a file stored in the third storage apparatus is migrated into the first storage apparatus, and
stores in a predetermined area of a storage area of the virtual volume an entity of a file, of files stored in the third storage apparatus, satisfying the predetermined condition, at the time of the second migration.

2. The server apparatus according to claim 1, wherein the predetermined storage area has allocated thereto a physical resource and is an assigned-unused area being a storage area currently in use.

3. The server apparatus according to claim 2, wherein
the first migration is performed by storing the entity of the file in the second storage apparatus, leaving meta data of the file in the first storage apparatus while deleting the entity of the file from the first storage apparatus,
the entity when receiving from the external apparatus, a data I/O request to the file stored in the second storage apparatus, performing a data I/O of the data I/O request by obtaining the entity from the second storage apparatus,
a feature of a file targeted by the first migration is extracted based on meta data of the file targeted by the first migration, and
in the second migration, the entity of a file of files stored in the third storage apparatus that has the feature and meets the predetermined condition is stored in the assigned-unused area.

4. The server apparatus according to claim 2, wherein
the first migration is performed by storing the entity of the file in the second storage apparatus, leaving meta data of the file in the first storage apparatus while deleting the entity of the file from the first storage apparatus,
upon receiving from the external apparatus a data I/O request to the file whose entity is stored in the second storage apparatus, data I/O of the data I/O request is performed by obtaining the entity from the second storage apparatus, and
when the assigned-unused area to be a storage destination of the file is lacking at the time of the second migration, the first migration is started for a file of files stored in the first storage apparatus that satisfies a pre-determined condition.

5. The server apparatus according to claim 2, wherein
the second migration is performed by a meta data of the file whose entity is stored in the third storage apparatus is stored in the first storage apparatus, and when receiving from the external apparatus a data I/O request to the file whose entity is stored in the third storage apparatus, a data I/O of the data I/O request is performed by obtaining the entity of the file from the third storage apparatus.

6. The server apparatus according to claim 5, wherein
the second migration is performed by
obtaining, from the third storage apparatus, information needed for generating a data I/O request to a file stored in the third storage apparatus,
generating a data I/O request for each of the files on the basis of the obtained information, and
performing data I/O of the data I/O request by obtaining the entity of the file from the third storage apparatus.

7. The server apparatus according to claim 6, wherein an assigned-unused area to store an entity of the file obtained from the third storage apparatus is secured before the second migration.

8. The server apparatus according to claim 2, wherein an upper limit of the available assigned-unused area for a single file is stored, and
an entity of a file that satisfies the predetermined condition is stored in the assigned-unused area that is allocated within the upper limit.

9. The server apparatus according to claim 2, wherein
allocation of the physical resource to the virtual volume is performed in units of pages, being a management unit of a storage pool in Thin Provisioning, and
the assigned-unused area is managed in units of data blocks.

10. A control method of an information system comprising
a first server apparatus that includes a file system and receives a data I/O request transmitted from an external apparatus to perform data I/O to a first storage apparatus,
a second server apparatus that is communicatively coupled to the first server apparatus and performs data I/O to a second storage apparatus, and
a third server apparatus that is communicatively coupled to the first server apparatus and performs data I/O to a third storage apparatus, the first storage apparatus providing the first server apparatus with a virtual volume being a virtual storage area provided by Thin Provisioning, the method comprising:
performing as needed a first migration, by which an entity of a file, of files stored in the first storage apparatus, satisfying a predetermined condition is migrated into the second storage apparatus,
performing as needed a second migration, by which an entity of a file stored in the third storage apparatus is migrated into the first storage apparatus, and
storing in an assigned-unused area, to which a physical resource is already assigned and currently not being used, of a storage area of the virtual volume, an entity of a file of files, stored in the third storage apparatus, satisfying the predetermined condition at the time of the second migration.

11. The control method of an information system according to claim 10, wherein
the first migration is performed by storing the entity of the file in the second storage apparatus, leaving meta data of the file in the first storage apparatus while deleting the entity of the file from the first storage apparatus, and
the first server apparatus
performs a data I/O of the data I/O request by obtaining the entity from the second storage apparatus, when the entity receives from the external apparatus a data I/O request to the file stored in the second storage apparatus,
extracts a feature of a file targeted by the first migration based on meta data of the file targeted by the first migration, and
stores the entity of a file of files stored in the third storage apparatus that has the feature and meets the predetermined condition in the assigned-unused area.

12. The control method of the information system according to claim 10, wherein
the first migration is performed by storing the entity of the file in the second storage apparatus, leaving meta data of the file in the first storage apparatus while deleting the entity of the file from the first storage apparatus, and
the first server apparatus
performs data I/O of the data I/O request by obtaining the entity from the second storage apparatus, upon receiving from the external apparatus a data I/O request to the file whose entity is stored in the second storage apparatus, and
starts the first migration for a file of files stored in the first storage apparatus that satisfies a predetermined condition, when the assigned-unused area to be used as the storage destination of the file is lacking for the second migration.

13. The control method of the information system according to claim 10, wherein
the first server apparatus performs the second migration by storing a meta data of the file whose entity is stored in the third storage apparatus is stored in the first storage apparatus, and performing a data I/O of the data I/O request by obtaining the entity of the file from the third storage apparatus when receiving from the external apparatus a data I/O request to the file whose entity is stored in the third storage apparatus.

14. The control method of the information system according to claim 10, wherein
the first server apparatus performs the second migration by obtaining, from the third storage apparatus, information needed for generating a data I/O request to a file stored in the third storage apparatus,
generating a data I/O request for each of the files on the basis of the obtained information, and performing data I/O of the data I/O request by obtaining the entity of the file from the third storage apparatus.

15. The control method of the information system according to claim 14, wherein
an assigned-unused area to store an entity of the file obtained from the third storage apparatus is secured before the second migration.
